(19) United States
(12) Patent Application Publication
(10) Pub. No.: US 2023/0237022 A1
(43) Pub. Date: Jul. 27, 2023

(54) PROTOCOL LEVEL CONNECTED FILE SHARE ACCESS IN A DISTRIBUTED FILE SERVER ENVIRONMENT

(71) Applicant: NUTANIX, INC., San Jose, CA (US)

(72) Inventors: Pradeep Thomas, San Jose, CA (US); Suhrud Patankar, Pune (IN); Srikrishan Malik, Pune (IN); Manoj Premanand Naik, San Jose, CA (US)

(73) Assignee: NUTANIX, INC., SAN JOSE, CA (US)

(21) Appl. No.: 17/582,750

(22) Filed: Jan. 24, 2022

(51) Int. Cl. G06F 16/176; G06F 16/182; G06F 16/11

(52) U.S. Cl. CPC G06F 16/176; G06F 16/183; G06F 16/122

(57) ABSTRACT

Examples described herein are generally directed towards file share access, and more specifically towards a mechanism to connect file shares at the protocol level in a distributed file server environment. In operation, a first FSVM hosting a first file share may receive a request by a client to access a location in a name space. The first FSVM may determine the location is at a second file share linked to the first file share. The first FSVM may provide access to the second file share to the client. In some examples, the first file share and the second file share may be linked at the directory level.

### TECHNICAL FIELD

Examples described herein relate generally to virtualized environments. Examples of systems and techniques are described which facilitate protocol connected file share access.

### BACKGROUND

Traditionally, when file shares are created on a file server, each file share includes its own control attributes (e.g., control polices, policies, etc.), resulting in each share having its own namespace and needing to be accessed separately. While creating multiple shares allows setting different control attributes, the creation of multiple namespaces results in a client needing to mount and access each share individually. For example, a client may wish to access a specific share using a first file server. In response, the file server may determine the location of the desired share, and direct the client where to locate the share and access the share. Upon learning of the share's the location, the client would need to locate and mount the share to obtain access. This is because the creation of the desired share also caused the creation of another namespace.

### BRIEF DESCRIPTION OF THE DRAWINGS

FIG. 1 is a schematic illustration of a system, arranged in accordance with examples described herein.

FIG. 2 is a schematic illustration of a clustered virtualization environment 200 implementing a virtualized file server in accordance with examples described herein.

FIG. 3 is a schematic illustration of a clustered virtualization environment 300 arranged in accordance with examples described herein.

FIG. 4 illustrates an example hierarchical structure of a VFS instance in a cluster according to particular embodiments.

FIG. 5 illustrates two example host machines, each providing file storage services for portions of two VFS instances FS1 and FS2 according to particular embodiments.

FIG. 6 illustrates example interactions between a client and host machines on which different portions of a VFS instance are stored arranged in accordance with examples described herein.

FIG. 7 is a schematic illustration of a system including linked or connected shares, arranged in accordance with examples described herein.

FIG. 8 is a schematic illustration of a computing system, arranged in accordance with examples described herein.

### DETAILED DESCRIPTION

Certain details are set forth herein to provide an understanding of described embodiments of technology. However, other examples may be practiced without various of these particular details. In some instances, well-known computing system components, virtualization operations, and/or software operations have not been shown in detail in order to avoid unnecessarily obscuring the described embodiments. Other embodiments may be utilized, and other changes may be made, without departing from the spirit or scope of the subject matter presented here.

Oftentimes, in traditional clustered systems, when file shares are created on a file server, each file share may include its own control attributes (e.g., control polices, policies, etc.). As a result, in some examples, each share may have its own namespace, and may need to be accessed separately. In some examples, while creating multiple shares may allow setting different control attributes and/or policies, the creation of multiple namespaces may often result in a client needing to mount and access each share individually. For example, a client may wish to access a specific share using a first file server. In response, the file server may determine the location of the desired share, and direct the client where to locate the share and access the share. Upon learning of the share's the location, the client would need to locate and mount the share to obtain access. In some examples, this is because the creation of the desired share also caused the creation of another namespace.

Advantageously, example embodiments described herein describe connecting shares to create a unified namespace while simultaneously retaining each share's unique attributes (e.g., policies, control policies, etc.) determined during share creation (e.g., by an administrative system, etc.). Operationally, and in some examples, the connection may occur internally and at the protocol level. This means that, in some examples there are no changes in the server-side file system or kernel, and that the connected shares may each retain their own attributes (e.g., policies). In some examples, this may also allow (e.g., clients) access to distributed data at the directory level across shares. In this way, clients with access to multiple shares located in different namespaces may, in some examples, access them from a single computing node using a single namespace due to the shares being connected (e.g. linked) in the backend and at the protocol layer.

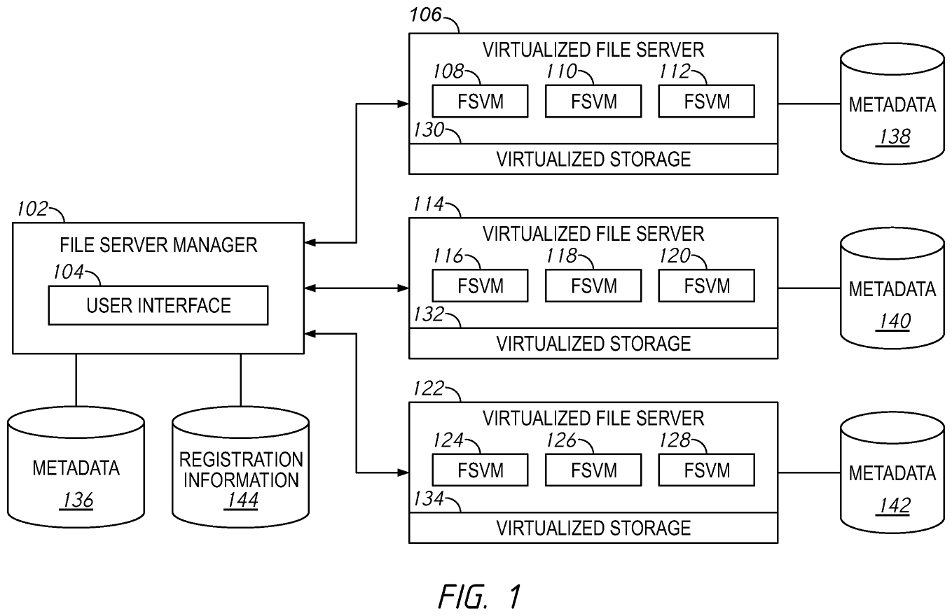

FIG. 1 is a schematic illustration of a system arranged in accordance with examples described herein. The system of FIG. 1 includes file server manager 102. The file server manager 102 may provide user interface 104. The file server manager 102 may be in communication with memory and/or storage for metadata 136 and registration information 144. The system of FIG. 1 further includes virtualized file server 106, virtualized file server 114, and virtualized file server 122. The virtualized file server 106, virtualized file server 114, and virtualized file server 122 may each be in communication with the file server manager 102 (e.g., over one or more networks). Each of the virtualized file server 106, virtualized file server 114, and virtualized file server 122 may be hosted in a same and/or different virtualization environment. Each of the virtualized file server 106, virtualized file server 114, and virtualized file server 122 may include a cluster of computing nodes hosting a cluster of file server virtual machines (FSVM). For example, the virtualized file server 106 includes FSVM 108, FSVM 110, and FSVM 112. The virtualized file server 114 includes FSVM 116, FSVM 118, and FSVM 120. The virtualized file server 122 includes FSVM 124, FSVM 126, and FSVM 128. Each of the virtualized file server 106, virtualized file server 114, and virtualized file server 122 may include virtualized storage. For example, the virtualized file server 106 may include virtualized storage 130, the virtualized file server 114 may include virtualized storage 132, and the virtualized file server 122 may include virtualized storage 134. Moreover, each of the virtualized file server 106, virtualized file server 114, and virtualized file server 122 may include storage and/or memory for storing metadata. The virtualized file server 106 may store metadata 138. The virtualized file server 114 may store metadata 140. The virtualized file server 122 may store metadata 142.

The components shown in FIG. 1 are exemplary only. Additional, fewer, and/or different components may be used in other examples. For example, three virtualized file servers are depicted in FIG. 1, however any number may be used and may be in communication with the file server manager 102.

Examples of systems described herein may accordingly include one or more virtualized file servers, such as virtualized file server 106, virtualized file server 114, and virtualized file server 122 in FIG. 1. A virtualized file server may represent a logical entity in the system. Virtualized file servers described herein may be hosted in generally any virtualization environment (e.g., on generally any virtualization platform). The virtualization environment and/or platform generally refers to the storage resources that have been virtualized by the virtualized file server and the compute resources (e.g., computing nodes with processor(s)) used to manage the virtualized storage. For example, the virtualized file server 106 may be hosted on a different virtualization environment than the virtualized file server 114 and/or than the virtualized file server 122. Nonetheless, in some examples one or more virtualized file servers in communication with a file server manager may be hosted in a same virtualization environment. Examples of virtualization environments include, for example, on premises installations of one or more computing nodes and storage devices. Examples of virtualization environment include one or more cloud computing systems (e.g., Amazon Web Services, MICROSOFT AZURE). Although not shown explicitly in FIG. 1, virtualization environments and/or virtualized file servers may include additional components including, but not limited to, one or more hypervisors, storage controllers, operating systems, and/or container orchestrators (e.g., Kubernetes). The multiple virtualized file servers in communication with a file server manager described herein may in some examples be located in different geographic locations (e.g., different buildings, states, cities, or countries).

A virtualized file server may include a cluster of virtual machines and/or other virtualized entities (e.g., containers), which may be referred to as file server virtual machines (FSVMs). In some examples, each of the file server virtual machines of a cluster may be implemented on different computing nodes forming a computing node cluster. For example, the FSVM 108, FSVM 110, and FSVM 112 of virtualized file server 106 may each be implemented on separate computing nodes of a computing node cluster used by the virtualized file server 106. Similarly, the FSVM 116, FSVM 118, and FSVM 120 may each be implemented on separate computing nodes of a computing node cluster used by the virtualized file server 114. Similarly, the FSVM 124, FSVM 126, and FSVM 128 may each be implemented on separate computing nodes of a computing nodes cluster. In some examples, a cluster of FSVMs may be implemented on a cloud computing system.

The FSVMs may operate to provide a file system on the storage resources of the virtualized file server. The file system may have a single namespace and may store data in accordance with filenames and/or directories. The FSVMs may accordingly support one or more file system protocols, such as NFS and/or SMB. A virtualized file server (such as virtualized file server 106, virtualized file server 114, and/or virtualized file server 122) may translate file system protocol requests for one or more files and/or directories (e.g., a file path) into one or more storage requests to access the data corresponding to the file, directory, and/or file path. Any of a variety of components of the virtualized file server may be used to perform the translation (e.g., one or more FSVMs, one or more hypervisors, and/or one or more storage controllers). The translation may be performed using a map (e.g., a shard map) relating the location of the data to the file name, share, directory, and/or file path.

Virtualized file servers described herein may include virtualized storage. For example, the virtualized file server 106 may include virtualized storage 130. The virtualized file server 114 may include virtualized storage 132. The virtualized file server 122 may include virtualized storage 134. The virtualized storage may generally include any number or kind of storage devices—for example, network attached storage, local storage of one or more computing nodes forming the virtualized file server, and/or cloud storage. Storage devices may be implemented using, for example one or more memories, hard disk drives, solid state drives. The virtualized storage for a particular virtualized file server may be referred to as a storage pool. The virtualized storage may store one or more shares. Generally, the virtualized storage may refer to a storage pool which may include any of a variety of storage devices. In some examples, the virtualized file server(s) may be implemented in a hyperconverged architecture. For example, the storage pool may include local storage devices of the computing nodes used to host the virtualized file server. For example, virtualized storage 130 may include a storage pool. One or more shares of a file system provided by the virtualized file server 106 may be distributed across storage device of the storage pool, including local storage devices of one or more computing nodes on which the FSVM 108, FSVM 110, and/or FSVM 112 reside. In some examples, each file server virtual machine (FSVM) may manage (e.g., host) a corresponding share or a portion of a share. A map may store associations between shares and files, directories, and/or file paths.

Virtualized file servers described herein may include metadata. For example, virtualized file server 106 may include metadata 138. The virtualized file server 114 may include metadata 140. The virtualized file server 122 may include metadata 142. The metadata may be stored, for example, in the virtualized storage and/or other storage location accessible to the virtualized file server. The metadata may in some examples be distributed across the storage pool of a virtualized file server. In some examples, the metadata may be stored in a database accessible to and/or hosted by the virtualized file server. Metadata stored by a virtualized file server may include, for example, authentication information for the virtualized file server and/or virtual machines in the virtualized file server, authorization information for the virtualized file server and/or virtual machines in the virtualized file server, configuration information for the virtualized file server and/or virtual machines in the virtualized file server, end point information (e.g., supported API calls and/or endpoints), a number of shares stored in the virtualized storage of the virtualized file server, a protocol supported by each share and/or FSVM (e.g., NFS and/or SMB), identities of the shares stored in the virtualized storage of the virtualized file server, a number of file server virtual machines (FSVMs) present in the virtualized file server, a number of files and/or directories hosted by the virtualized file server, compute resources available and/or used at the virtualized file server, storage resources available and/or used at the virtualized file server, or other metadata regarding the virtualized file server. The metadata may be maintained by the virtualized file server, for example, the metadata may be updated as the number of shares, FSVMs, storage resources and/or compute resources change.

Examples described herein may include a file server manager, such as file server manager 102 of FIG. 1. A file server manager may be in communication with multiple virtualized file servers. For example, the file server manager 102 may be in communication with virtualized file server 106, virtualized file server 114, and virtualized file server 122. In this manner, the file server manager 102 may allow for access to, maintenance of, and/or management of multiple virtualized file servers (e.g., multiple file systems). An enterprise may have many virtualized file servers that are desired to be managed—for example, different geographic locations of the enterprise may maintain separate file systems and/or implement different privacy or other data policies. In some examples, different departments or entities within an organization may maintain respective virtualized file servers. An administrator or other entity associated with the enterprise, such as an IT manager, may advantageously view, access, and/or manage multiple virtualized file servers using the file server manager (e.g., file server manager 102). The file server manager may communicate with each virtualized file server using any of a variety of connections, including one or more networks. In some examples, a same network may be used to communicate between the file server manager and multiple virtualized file servers. In some examples, multiple networks may be used.

File server managers, such as file server manager 102 of FIG. 1 may be implemented using one or more computing devices. In some example, an administrative computing system may be used. The administrative computing system may include, for example, one or more processors and non-transitory computer readable media encoded with instructions for performing the file server manager operations described herein. In some examples, the file server manager may be implemented using a computing device different than the computing devices (e.g., computing nodes) used to implement the virtualized file server(s) with which the file server manager is in communication. In some examples, the file server manager may be hosted on one of the computing nodes forming a part of a virtualized file server in communication with the file server manager. File server managers, such as file server manager 102, may be hosted on premises systems in some examples, and/or on cloud computing systems in some examples.

Examples of file server managers described herein may provide one or more user interfaces, such as user interface 104 of FIG. 1. The user interface may allow a user (e.g., a human administrator and/or another computer process) to view information regarding multiple virtualized file servers, to communicate with multiple virtualized file servers, to manage multiple virtualized file servers, and generally to offer a single pane of glass interface to the multiple virtualized file servers in communication with the file server manager. The user interface may be implemented, for example, using one or more display(s) and one or more input and/or output device(s) (e.g., mouse, keyboard, touchscreen, etc.). In some examples, user interface 104 of file server manager 102 may be used to depict one or more of the virtualized file server 106, virtualized file server 114, and/or virtualized file server 122. For example, the identity and number of shares used by the virtualized file servers may be displayed. In some examples, the number and identity of computing nodes and/or FSVMs in each of the virtualized file servers may be displayed. Other attributes of the virtualized file servers may additionally or instead be displayed using a user interface of a file server manager. The data used in the display may wholly and/or partially be obtained from the registration information and/or metadata synchronized with one or more of the virtualized file servers.

Examples of file server managers described herein may store registration information, such as registration information 144 of FIG. 1. The registration information 144 may include information regarding each virtualized file server in communication with the file server manager. The registration information may include information used to manage, communicate with, and/or otherwise interact with the virtualized file server. Examples of registration information include a name of the virtualized file server, an identification of the virtualization environment hosting the virtualized file server, credentials for one or more FSVMs in the virtualized file server, IP addresses or other addresses for the virtualized file server, FSVMs in the virtualized file server, or other components of the virtualized file server. During setup of a system including a file server manager, the virtualized file servers may be registered with the file server manager, and may provide registration information to the file server manager. The registration information may be stored by the file server manager, such as in registration information 144, which may be a database in some examples. The registration information may be stored on a memory and/or other storage device accessible to the file server manager.

Examples of file server managers described herein may include metadata, such as metadata 136. The metadata may be synchronized to the metadata of multiple virtualized file servers in communication with the file server manager. For example, the metadata 136 may be synchronized with metadata 138, metadata 140, and metadata 142. For example, the metadata 136 at any given time may include metadata 138, metadata 140, and metadata 142. Synchronization may be maintained over time—the metadata of multiple virtualized file servers may periodically (e.g., at regular and/or irregular intervals) synchronize with the metadata store of the file server manager. In this manner, the file server manager 102 may maintain an updated storage of metadata associated with each of virtualized file server 106, virtualized file server 114, and virtualized file server 122. The metadata may be accessed by the file server manager and used to manage, communicate with, and/or otherwise interact with the virtualized file servers.

While the metadata 136 and registration information 144 are depicted separately in FIG. 1, they may be wholly and/or partially stored on a same storage device in some examples. The metadata 136 may be stored, for example, in a database. The registration information 144 may be stored, for example, in a database. Any of a variety of database synchronization techniques may be used to synchronize the metadata of the file server manager with the metadata of multiple virtualized file servers.

During operation, a file server manager described herein may register, such as by receiving a registration for, one or more virtualized file servers. For example, a virtualized file server (e.g., using an FSVM, a hypervisor, and/or another component of the virtualized file server), may transmit a registration (e.g., registration information) to the file server manager. In some examples, the file server manager may request such a registration by transmitting a request to register to the virtualized file server. In some examples, such as when the file server manager is hosted on a cluster and/or within a same system as the virtualized file server, an automatic registration may occur. For example, the registration process may include determining (e.g., from one or more IP addresses used), that a virtualized file server is hosted on a same domain as a file server manager. In other examples, virtualized file servers which are not hosted on a same domain as a file server manager may nonetheless register with the file server manager. In the example of FIG. 1, the file server manager 102 may request registration from virtualized file server 106, virtualized file server 114, and virtualized file server 122. For example, a system administrator may enter an IP address, name, or other identifier to request a registration from virtualized file server 106, virtualized file server 114, and/or virtualized file server 122. In some examples, a system administrator or other user or component may transmit a registration from virtualized file server 106, virtualized file server 114, and/or virtualized file server 122, which registration may or may not be responsive to a request. In some examples, the operating system of one or more computing nodes of the virtualized file server hosting an FSVM may provide a registration request to the file server manager. The registration may include registration information which file server manager 102 may store in registration information 144.

The file server manager may synchronize metadata of registered file servers such that up to date metadata of the registered file server may be accessible to the file server manager. For example, the metadata 136 may synchronize with metadata 138, metadata 140, and metadata 142 of FIG. 1. Any and/or all types of metadata of the virtualized file server may be synched with a file server manager. For example, a number and identity of shares of each virtualized file server may be synchronized with the file server manager. In some examples, compute and/or storage resource usage may additionally or instead be synchronized between a virtualized file server and the file server manager. Sharding or other maps and/or portions thereof may be synchronized between a virtualized file server and the file server manager. Other metadata may be synchronized additionally or instead.

During operation, file server managers described herein, such as file server manager 102 of FIG. 1 may receive a management request for a particular virtualized file server. The management request may be received, for example by a client which may be hosted on a client system, on a system also hosting the file server manager, and/or on a system hosting all or a portion of one of the virtualized file servers in communication with the file server manager. In some examples, the management request may be implemented using an API call. In this manner, a file server manager may provide an API endpoint to receive API calls for one or more virtualized file servers. Examples of management requests include requests for accessing, managing, and/or maintaining the virtualized file server. For example, a management request may be a request to add and/or subtract one or more FSVMs, add and/or subtract one or more shares in the storage, and/or upgrade one or more FSVMs.

The file server manager may format the received management request for the virtualization environment (e.g., virtualization platform) used to host the requested virtualized file server. For example, the file server manager may access the registration information 144 to identify a virtualization environment for a virtualized file server identified in the management request. The management request may then be formatted in a manner used by the virtualized environment. In some examples, the formatted management request may be implemented as an API call, with the API call specific to the virtualization environment of the target virtualized file server. In this manner, clients or other users providing management requests to the file server manager may not require knowledge of the virtualized environment hosting the virtualized file server. The file server manager may format the request in the manner used to communicate with the appropriate virtualization environment. This may provide flexibility in system design and usage, as multiple virtualization environments may be used, and virtualized file servers may in some examples be relocated from one virtualized environment to another without a need to update management requests being provided to the file server manager. Instead, an updated identification of the virtualized environment may be stored in registration information 144 and/or metadata 136.

During operation, the file server manager may utilize information from the registration to implement the management request. For example, access credentials provided during registration may be used to access one or more FSVMs and/or other components of the virtualized file server (e.g., hypervisor, other virtual machine(s) and/or container(s)) and implement the management request. In some examples, the management request may be provided to a particular FSVM. In some examples, the management request may be provided to an FSVM of the virtualized file server that is designated as a leader, and the leader FSVM may communicate the management request to an appropriate FSVM of the virtualized file server.

In some examples, file server managers described herein, such as file server manager 102 of FIG. 1, may be used to implement one or more cross-file server policies. A cross-file server policy may generally refer to a policy that accesses and/or utilizes more than one file server in implementing the policy. For example, one virtualized file server may be used (e.g., designated) as a destination file server and another virtualized file server may be used (e.g., designated) as a source file server. For example, the file server manager 102 may designate virtualized file server 106 as a source file server and virtualized file server 114 as a destination file server. The file server manager 102 may then utilize virtualized file server 106 to replicate, backup, provide redundancy for, or otherwise receive data from virtualized file server 106. For example, the file server manager 102 may implement a replication policy from virtualized file server 106 to virtualized file server 114. Without the presence of file server manager 102 in some examples, the virtualized file server 106 may have been used to implement a replication policy to virtualized file server 114 directly. However, utilizing file server manager 102 provides for central cross-server management and avoids a need for individual file servers to communicate with one another directly.

Examples of systems and methods described herein may include a file server manager in communication with one or more virtualized file servers. Examples of virtualized file servers which may be used to implement virtualized file servers described in, for example, U.S. Published Patent Application 2017/0235760, entitled “Virtualized file server,” published Aug. 17, 2017 on U.S. application Ser. No. 15/422,220 (deleted), filed Feb. 1, 2017, both of which documents are hereby incorporated by reference in their entirety for any purpose.

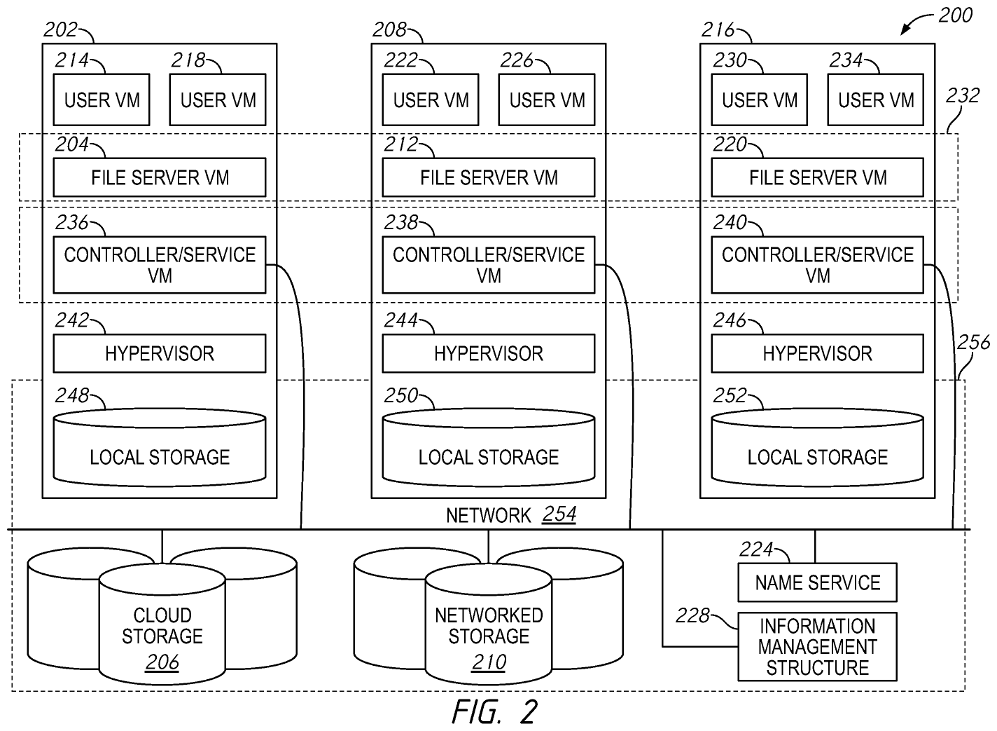

FIG. 2 is a schematic illustration of a clustered virtualization environment 200 implementing a virtualized file server (VFS 232) according to particular embodiments. In particular embodiments, the VFS 232 provides file services to user VMs 214, 218, 222, 226, 230, and 234. Each user VM may be a client as used herein. The file services may include storing and retrieving data persistently, reliably, and efficiently. The user virtual machines may execute user processes, such as office applications or the like, on host machines 202, 208, and 216. The stored data may be represented as a set of storage items, such as files organized in a hierarchical structure of folders (also known as directories), which can contain files and other folders, and shares, which can also contain files and folders.

The clustered virtualization environment 200 and/or VFS 232 may be used to implement one or more virtualization platforms and/or virtualized file servers described herein, such as the virtualized file server 106, virtualized file server 114, and/or virtualized file server 122 of FIG. 1 and/or any other virtualized file server described herein.

The architectures of FIG. 2 can be implemented for a distributed platform that contains multiple host machines 202, 216, and 208 that manage multiple tiers of storage. The multiple tiers of storage may include storage that is accessible through network 254, such as, by way of example and not limitation, cloud storage 206 (e.g., which may be accessible through the Internet), network-attached storage 210 (NAS) (e.g., which may be accessible through a LAN), or a storage area network (SAN). Examples described herein also permit local storage 248, 250, and 252 that is incorporated into or directly attached to the host machine and/or appliance to be managed as part of storage pool 256. Examples of such local storage include Solid State Drives (henceforth “SSDs”), Hard Disk Drives (henceforth “HDDs” or “spindle drives”), optical disk drives, external drives (e.g., a storage device connected to a host machine via a native drive interface or a serial attached SCSI interface), or any other direct-attached storage. These storage devices, both direct-attached and network-accessible, collectively form storage pool 256. Virtual disks (or “vDisks”) may be structured from the physical storage devices in storage pool 256. As used herein, the term vDisk refers to the storage abstraction that is exposed by a component of the virtualization platform, such as a Controller/Service VM (CVM) (e.g., CVM 236) and/or a hypervisor or other storage controller to be used by a user VM (e.g., user VM 214). In particular embodiments, the vDisk may be exposed via iSCSI (“internet small computer system interface”) or NFS (“network filesystem”) and is mounted as a virtual disk on the user VM. In particular embodiments, vDisks may be organized into one or more volume groups (VGs).

Each host machine 202, 216, 208 may run virtualization software, such as VMWARE ESX(I), MICROSOFT HYPER-V, or REDHAT KVM. The virtualization software includes hypervisors 242, 244, and 246 to create, manage, and destroy user VMs, as well as managing the interactions between the underlying hardware and user VMs. User VMs may run one or more applications that may operate as “clients” with respect to other elements within clustered virtualization environment 200. A hypervisor may connect to network 254. In particular embodiments, a host machine 202, 208, or 216 may be a physical hardware computing device; in particular embodiments, a host machine 202, 208, or 216 may be a virtual machine.

CVMs 236, 238, and 240 are used to manage storage and input/output (“I/O”) activities according to particular embodiments. These special VMs act as the storage controller in the currently described architecture. Multiple such storage controllers may coordinate within a cluster to form a unified storage controller system. CVMs may run as virtual machines on the various host machines, and work together to form a distributed system that manages all the storage resources, including local storage, network-attached storage 210, and cloud storage 206. The CVMs may connect to network 254 directly, or via a hypervisor. Since the CVMs run independent of hypervisors 242, 244, 246, this means that the current approach can be used and implemented within any virtual machine architecture, since the CVMs of particular embodiments can be used in conjunction with any hypervisor from any virtualization vendor. In some examples, CVMs may not be used and one or more hypervisors (e.g., hypervisors 242, 244, and/or 246) may perform the functions described with respect to the CVMs. In some examples, one or more CVMs may not be present, and the hypervisor or other component hosted on the computing nodes may provide the functions attributed to the CVM herein.

A host machine may be designated as a leader node within a cluster of host machines. For example, host machine 208, may be a leader node. A leader node may have a software component designated to perform operations of the leader. For example, CVM 238 on host machine 208 may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node and/or in communication with the leader node or virtual machines or containers on the leader node. For example, file server managers described herein may be in communication with the leader node in some examples.

Each CVM 236, 238, and 240 exports one or more block devices or NFS server targets that appear as disks to user VMs 214, 218, 222, 226, 230, and 234. These disks are virtual, since they are implemented by the software running inside CVMs 236, 238, and 240. Thus, to user VMs, CVMs appear to be exporting a clustered storage appliance that contains some disks. All user data (including the operating system) in the user VMs may reside on these virtual disks.

Significant performance advantages can be gained by allowing the virtualization system to access and utilize local storage 248, 250, and 252 as disclosed herein. This is because I/O performance is typically much faster when performing access to local storage as compared to performing access to network-attached storage 210 across a network 254. This faster performance for locally attached storage can be increased even further by using certain types of optimized local storage devices, such as SSDs. Further details regarding methods and mechanisms for implementing the virtualization environment illustrated in FIG. 2 are described in U.S. Pat. No. 8,601,473, which is hereby incorporated by reference in its entirety.

As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 256. Additionally or alternatively, CVMs 236, 238, 240 may present an emulated storage controller either to the hypervisor or to user VMs to facilitate I/O operations. CVMs 236, 238, and 240 may be connected to storage within storage pool 256. CVM 236 may have the ability to perform I/O operations using local storage 248 within the same host machine 202, by connecting via network 254 to cloud storage 206 or network-attached storage 210, or by connecting via network 254 to local storage 250 or 252 within another host machine 208 or 216 (e.g., via connecting to another CVM 238 or 240). In particular embodiments, any suitable computing system may be used to implement a host machine.

In particular embodiments, the VFS 232 may include a set of File Server Virtual Machines (FSVMs) 204, 212, and 220 that execute on host machines 202, 208, and 216 and process storage item access operations requested by user VMs executing on the host machines 202, 208, and 216. The FSVMs 204, 212, and 220 may communicate with storage controllers provided by CVMs 236, 244, 240 and/or hypervisors executing on the host machines 202, 208, 216 to store and retrieve files, folders, SMB shares, or other storage items on local storage 248, 250, 252 associated with, e.g., local to, the host machines 202, 208, 216. The FSVMs 204, 212, 220 may store and retrieve block-level data on the host machines 202, 208, 216, e.g., on the local storage 248, 250, 252 of the host machines 202, 208, 216. The block-level data may include block-level representations of the storage items (e.g., files). The network protocol used for communication between user VMs, FSVMs, and CVMs via the network 254 may be Internet Small Computer Systems Interface (iSCSI), Server Message Block (SMB), Network Filesystem (NFS), pNFS (Parallel NFS), or another appropriate protocol.

For the purposes of VFS 232, host machine 216 may be designated as a leader node within a cluster of host machines. In this case, FSVM 220 on host machine 216 may be designated to perform such operations. A leader may be responsible for monitoring or handling requests from FSVMs on other host machines throughout the virtualized environment. If FSVM 220 fails, a new leader may be designated for VFS 232.

In particular embodiments, the user VMs may send data to the VFS 232 (e.g., to the FSVMs) using write requests, and may receive data from it using read requests. The read and write requests, and their associated parameters, data, and results, may be sent between a user VM and one or more file server VMs (FSVMs) located on the same host machine as the user VM or on different host machines from the user VM. The read and write requests may be sent between host machines 202, 208, 216 via network 254, e.g., using a network communication protocol such as iSCSI, CIFS, SMB, TCP, IP, or the like. When a read or write request is sent between two VMs located on the same one of the host machines 202, 208, 216 (e.g., between the user VM 214 and the FSVM 204 located on the host machine 202), the request may be sent using local communication within the host machine 202 instead of via the network 254. As described above, such local communication may be substantially faster than communication via the network 254. The local communication may be performed by, e.g., writing to and reading from shared memory accessible by the user VM 214 and the FSVM 204, sending and receiving data via a local “loopback” network interface, local stream communication, or the like.

In particular embodiments, the storage items stored by the VFS 232, such as files and folders, may be distributed amongst multiple FSVMs 204, 212, 220. In particular embodiments, when storage access requests are received from the user VMs, the VFS 232 identifies FSVMs 204, 212, 220 at which requested storage items, e.g., folders, files, or portions thereof, are stored, and directs the user VMs to the locations of the storage items. The FSVMs 204, 212, 220 may maintain a storage map, such as a sharding map, that maps names or identifiers of storage items to their corresponding locations. The storage map may be a distributed data structure of which copies are maintained at each FSVM 204, 212, 220 and accessed using distributed locks or other storage item access operations. Alternatively, the storage map may be maintained by an FSVM at a leader node such as the FSVM 220, and the other FSVMs 204 and 212 may send requests to query and update the storage map to the leader FSVM 220. Other implementations of the storage map are possible using appropriate techniques to provide asynchronous data access to a shared resource by multiple readers and writers. The storage map may map names or identifiers of storage items in the form of text strings or numeric identifiers, such as folder names, files names, and/or identifiers of portions of folders or files (e.g., numeric start offset positions and counts in bytes or other units) to locations of the files, folders, or portions thereof. Locations may be represented as names of FSVMs, e.g., “FSVM-1”, as network addresses of host machines on which FSVMs are located (e.g., “ip-addr1” or 128.1.1.10), or as other types of location identifiers.

When a user application executing in a user VM 214 on one of the host machines 202 initiates a storage access operation, such as reading or writing data, the user VM 214 may send the storage access operation in a request to one of the FSVMs 204, 212, 220 on one of the host machines 202, 208, 216. A FSVM 212 executing on a host machine 208 that receives a storage access request may use the storage map to determine whether the requested file or folder is located on the FSVM 212. If the requested file or folder is located on the FSVM 212, the FSVM 212 executes the requested storage access operation. Otherwise, the FSVM 212 responds to the request with an indication that the data is not on the FSVM 212, and may redirect the requesting user VM 214 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 204 by sending a file service operation that creates the file or folder to a CVM 236 and/or hypervisor 242 associated with (e.g., located on the same host machine as) the FSVM 204. The CVM 236 subsequently processes file service commands for that file for the FSVM 204 and sends corresponding storage access operations to storage devices associated with the file. The CVM 236 may associate local storage 248 with the file if there is sufficient free space on local storage 248. Alternatively, the CVM 236 may associate a storage device located on another host machine 202, e.g., in local storage 250, with the file under certain conditions, e.g., if there is insufficient free space on the local storage 248, or if storage access operations between the CVM 236 and the file are expected to be infrequent. Files and folders, or portions thereof, may also be stored on other storage devices, such as the network-attached storage (NAS) network-attached storage 210 or the cloud storage 206 of the storage pool 256.

In particular embodiments, a name service 224, such as that specified by the Domain Name System (DNS) Internet protocol, may communicate with the host machines 202, 208, 216 via the network 254 and may store a database of domain name (e.g., host name) to IP address mappings. The domain names may correspond to FSVMs, e.g., fsvm1.domain.com or ip-addr1.domain.com for an FSVM named FSVM-1. The name service 224 may be queried by the user VMs to determine the IP address of a particular host machine 202, 208, 216 given a name of the host machine, e.g., to determine the IP address of the host name ip-addr1 for the host machine 202. The name service 224 may be located on a separate server computer system or on one or more of the host machines 202, 208, 216. The names and IP addresses of the host machines of the VFS 232, e.g., the host machines 202, 208, 216, may be stored in the name service 224 so that the user VMs may determine the IP address of each of the host machines 202, 208, 216, or FSVMs 204, 212, 220. The name of each VFS instance, e.g., each file system such as FS1, FS2, or the like, may be stored in the name service 224 in association with a set of one or more names that contains the name(s) of the host machines 202, 208, 216 or FSVMs 204, 212, 220 of the VFS instance VFS 232. The FSVMs 204, 212, 220 may be associated with the host names ip-addr1, ip-addr2, and ip-addr3, respectively. For example, the file server instance name FS1.domain.com may be associated with the host names ip-addr1, ip-addr2, and ip-addr3 in the name service 224, so that a query of the name service 224 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 224 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 224 for the address of the VFS instance for storage items for which the user VMs do not have a record or cache entry, as described below.

In particular embodiments, each FSVM may have two IP addresses: an external IP address and an internal IP address. The external IP addresses may be used by SMB/CIFS clients, such as user VMs, to connect to the FSVMs. The external IP addresses may be stored in the name service 224. The IP addresses ip-addr1, ip-addr2, and ip-addr3 described above are examples of external IP addresses. The internal IP addresses may be used for iSCSI communication to CVMs and/or hypervisors, e.g., between the FSVMs 204, 212, 220 and the CVMs 236, 244, 240 and/or hypervisors 242, 244, and/or 246. Other internal communications may be sent via the internal IP addresses as well, e.g., file server configuration information may be sent from the CVMs to the FSVMs using the internal IP addresses, and the CVMs may get file server statistics from the FSVMs via internal communication as needed.

Since the VFS 232 is provided by a distributed set of FSVMs 204, 212, 220, the user VMs that access particular requested storage items, such as files or folders, do not necessarily know the locations of the requested storage items when the request is received. A distributed file system protocol, e.g., MICROSOFT DFS or the like, is therefore used, in which a user VM 214 may request the addresses of FSVMs 204, 212, 220 from a name service 224 (e.g., DNS). The name service 224 may send one or more network addresses of FSVMs 204, 212, 220 to the user VM 214, in an order that changes for each subsequent request. These network addresses are not necessarily the addresses of the FSVM 212 on which the storage item requested by the user VM 214 is located, since the name service 224 does not necessarily have information about the mapping between storage items and FSVMs 204, 212, 220. Next, the user VM 214 may send an access request to one of the network addresses provided by the name service, e.g., the address of FSVM 212. The FSVM 212 may receive the access request and determine whether the storage item identified by the request is located on the FSVM 212. If so, the FSVM 212 may process the request and send the results to the requesting user VM 214. However, if the identified storage item is located on a different FSVM 220, then the FSVM 212 may redirect the user VM 214 to the FSVM 220 on which the requested storage item is located by sending a “redirect” response referencing FSVM 220 to the user VM 214. The user VM 214 may then send the access request to FSVM 220, which may perform the requested operation for the identified storage item.

A particular virtualized file server, such as VFS 232, including the items it stores, e.g., files and folders, may be referred to herein as a VFS “instance” and/or a file system and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients such as user VMs by name, e.g., “\Folder-1 \File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1 \File-1”, in storage access operations. If the storage items are stored on a share (e.g., a shared drive), then the share name may be used to access the storage items, e.g., via the path name “\\Share-1 \Folder-1 \File-1” to access File-1 in folder Folder-1 on a share named Share-1.

In particular embodiments, although the VFS instance may store different folders, files, or portions thereof at different locations, e.g., on different FSVMs, the use of different FSVMs or other elements of storage pool 256 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, are similarly location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 232 determines the location, e.g., FSVM, at which to store a storage item when the storage item is created. For example, a FSVM 204 may attempt to create a file or folder using a CVM 236 on the same host machine 202 as the user VM 218 that requested creation of the file, so that the CVM 236 that controls access operations to the file folder is co-located with the user VM 218. In this way, since the user VM 218 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 232 may also attempt to store the file on a storage device that is local to the CVM being used to create the file, such as local storage, so that storage access operations between the CVM and local storage may use local or short-distance communication.

In particular embodiments, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In particular embodiments, if a virtual machine, such as a user VM 214, CVM 236, or FSVM 204, moves from a host machine 202 to a destination host machine 208, e.g., because of resource availability changes, and data items such as files or folders associated with the VM are not locally accessible on the destination host machine 208, then data migration may be performed for the data items associated with the moved VM to migrate them to the new host machine 208, so that they are local to the moved VM on the new host machine 208. FSVMs may detect removal and addition of CVMs (as may occur, for example, when a CVM fails or is shut down) via the iSCSI protocol or other technique, such as heartbeat messages. As another example, a FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 232 may change the location of the file by, for example, copying the file from its existing location(s), such as local storage 248 of a host machine 202, to its new location(s), such as local storage 250 of host machine 208 (and to or from other host machines, such as local storage 252 of host machine 216 if appropriate), and deleting the file from its existing location(s). Write operations on the file may be blocked or queued while the file is being copied, so that the copy is consistent. The VFS 232 may also redirect storage access requests for the file from an FSVM at the file's existing location to a FSVM at the file's new location.

In particular embodiments, VFS 232 includes at least three File Server Virtual Machines (FSVMs) 204, 212, 220 located on three respective host machines 202, 208, 216. To provide high-availability, there may be a maximum of one FSVM for a particular VFS instance VFS 232 per host machine in a cluster. If two FSVMs are detected on a single host machine, then one of the FSVMs may be moved to another host machine automatically, or the user (e.g., system administrator and/or file server manager) may be notified to move the FSVM to another host machine. The user and/or file server manager may move a FSVM to another host machine using an administrative interface that provides commands for starting, stopping, and moving FSVMs between host machines.

In particular embodiments, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which would be more disruptive and more difficult to recover from than loss of one-third of the FSVMs for the VFS instance.

In particular embodiments, users, such as system administrators or other users of the user VMs, may expand the cluster of FSVMs by adding additional FSVMs. Each FSVM may be associated with at least one network address, such as an IP (Internet Protocol) address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as name service.

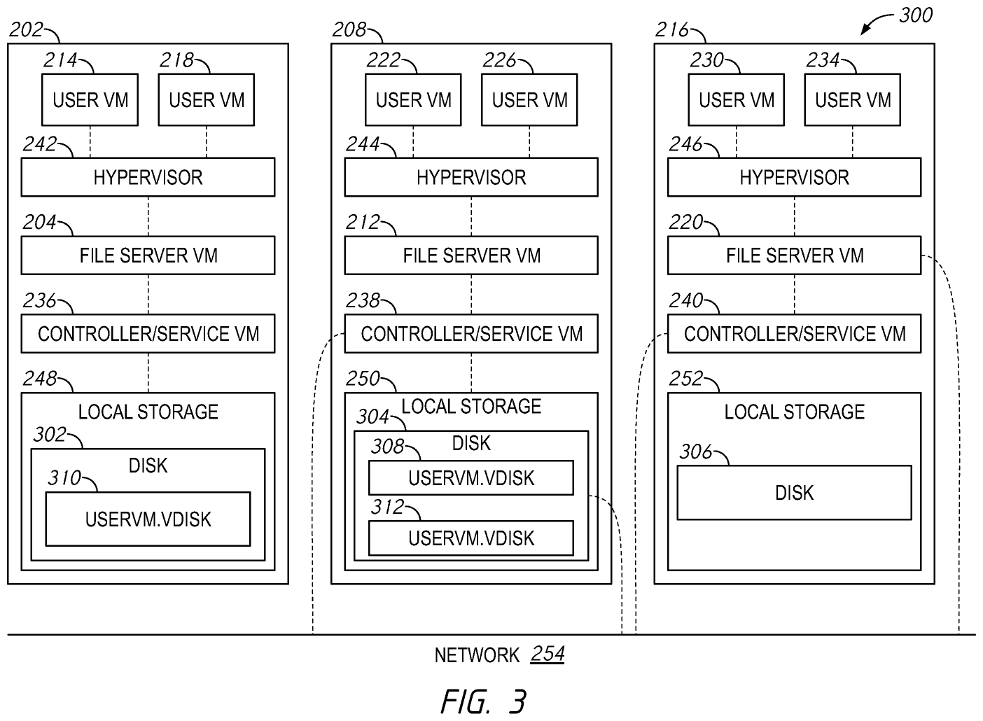

FIG. 3 illustrates data flow within a clustered virtualization environment 300 implementing a VFS instance (e.g, VFS 232) in which stored items such as files and folders used by user VMs are stored locally on the same host machines as the user VMs according to particular embodiments. As described above, one or more user VMs and a Controller/Service VM and/or hypervisor may run on each host machine along with a hypervisor. As a user VM processes I/O commands (e.g., a read or write operation), the I/O commands may be sent to the hypervisor on the same server or host machine as the user VM. For example, the hypervisor may present to the user VMs a VFS instance, receive an I/O command, and facilitate the performance of the I/O command by passing the command to a FSVM that performs the operation specified by the command. The VFS may facilitate I/O operations between a user VM and a virtualized file system. The virtualized file system may appear to the user VM as a namespace of mappable shared drives or mountable network file systems of files and directories. The namespace of the virtualized file system may be implemented using storage devices in the local storage, such as disks, onto which the shared drives or network file systems, files, and folders, or portions thereof, may be distributed as determined by the FSVMs. The VFS may thus provide features disclosed herein, such as efficient use of the disks, high availability, scalability, and others. The implementation of these features may be transparent to the user VMs. The FSVMs may present the storage capacity of the disks of the host machines as an efficient, highly-available, and scalable namespace in which the user VMs may create and access shares, files, folders, and the like.

As an example, a network share may be presented to a user VM as one or more discrete virtual disks, but each virtual disk may correspond to any part of one or more virtual or physical disks within a storage pool. Additionally or alternatively, the FSVMs may present a VFS either to the hypervisor or to user VMs of a host machine to facilitate I/O operations. The FSVMs may access the local storage via Controller/Service VMs, other storage controllers, hypervisors, or other components of the host machine. As described herein, a CVM 236 may have the ability to perform I/O operations using local storage 248 within the same host machine 202 by connecting via the network 254 to cloud storage or NAS, or by connecting via the network 254 to 250, 252 within another host machine 208, 216 (e.g., by connecting to another CVM 238, 240).

In particular embodiments, each user VM may access one or more virtual disk images stored on one or more disks of the local storage, the cloud storage, and/or the NAS. The virtual disk images may contain data used by the user VMs, such as operating system images, application software, and user data, e.g., user home folders and user profile folders. For example, FIG. 3 illustrates three virtual machine images 310, 308, 312. The virtual machine image 310 may be a file named UserVM.vmdisk (or the like) stored on disk 302 of local storage 248 of host machine 202. The virtual machine image 310 may store the contents of the user VM 214's hard drive. The disk 302 on which the virtual machine image 310 is “local to” the user VM 214 on host machine 202 because the disk 302 is in local storage 248 of the host machine 202 on which the user VM 214 is located. Thus, the user VM 214 may use local (intra-host machine) communication to access the virtual machine image 310 more efficiently, e.g., with less latency and higher throughput, than would be the case if the virtual machine image 310 were stored on disk 304 of local storage 250 of a different host machine 208, because inter-host machine communication across the network 254 would be used in the latter case. Similarly, a virtual machine image 308, which may be a file named UserVM.vmdisk (or the like), is stored on disk 304 of local storage 250 of host machine 208, and the image 308 is local to the user VM 222 located on host machine 208. Thus, the user VM 222 may access the virtual machine image 308 more efficiently than the virtual machine 218 on host machine 202, for example. In another example, the CVM 240 may be located on the same host machine 216 as the user VM 230 that accesses a virtual machine image 312 (UserVM.vmdisk) of the user VM 230, with the virtual machine image file 312 being stored on a different host machine 208 than the user VM 230 and the CVM 240. In this example, communication between the user VM 230 and the CVM 240 may still be local, e.g., more efficient than communication between the user VM 230 and a CVM 238 on a different host machine 208, but communication between the CVM 240 and the disk 304 on which the virtual machine image 312 is stored is via the network 254, as shown by the dashed lines between CVM 240 and the network 254 and between the network 254 and local storage 250. The communication between CVM 240 and the disk 304 is not local, and thus may be less efficient than local communication such as may occur between the CVM 240 and a disk 306 in local storage 252 of host machine 216. Further, a user VM 230 on host machine 216 may access data such as the virtual disk image 312 stored on a remote (e.g., non-local) disk 304 via network communication with a CVM 238 located on the remote host machine 208. This case may occur if CVM 240 is not present on host machine 216, e.g., because CVM 240 has failed, or if the FSVM 220 has been configured to communicate with 250 on host machine 208 via the CVM 238 on host machine 208, e.g., to reduce computational load on host machine 216.

In particular embodiments, since local communication is expected to be more efficient than remote communication, the FSVMs may store storage items, such as files or folders, e.g., the virtual disk images, as block-level data on local storage of the host machine on which the user VM that is expected to access the files is located. A user VM may be expected to access particular storage items if, for example, the storage items are associated with the user VM, such as by configuration information. For example, the virtual disk image 310 may be associated with the user VM 214 by configuration information of the user VM 214. Storage items may also be associated with a user VM via the identity of a user of the user VM. For example, files and folders owned by the same user ID as the user who is logged into the user VM 214 may be associated with the user VM 214. If the storage items expected to be accessed by a user VM 214 are not stored on the same host machine 202 as the user VM 214, e.g., because of insufficient available storage capacity in local storage 248 of the host machine 202, or because the storage items are expected to be accessed to a greater degree (e.g., more frequently or by more users) by a user VM 222 on a different host machine 208, then the user VM 214 may still communicate with a local CVM 236 to access the storage items located on the remote host machine 208, and the local CVM 236 may communicate with local storage 250 on the remote host machine 208 to access the storage items located on the remote host machine 208. If the user VM 214 on a host machine 202 does not or cannot use a local CVM 236 to access the storage items located on the remote host machine 208, e.g., because the local CVM 236 has crashed or the user VM 214 has been configured to use a remote CVM 238, then communication between the user VM 214 and local storage 250 on which the storage items are stored may be via a remote CVM 238 using the network 254, and the remote CVM 238 may access local storage 250 using local communication on host machine 208. As another example, a user VM 214 on a host machine 202 may access storage items located on a disk 306 of local storage 252 on another host machine 216 via a CVM 238 on an intermediary host machine 208 using network communication between the host machines 202 and 208 and between the host machines 208 and 216.

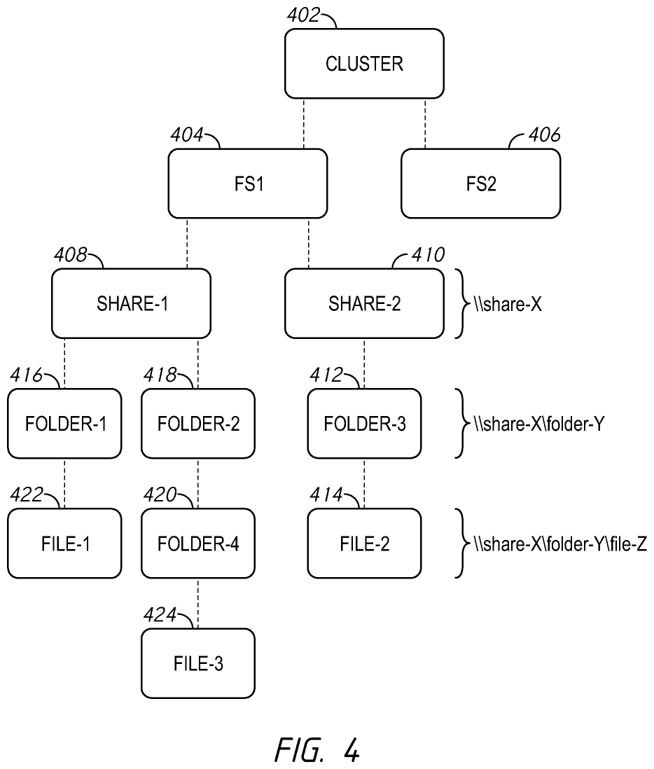

FIG. 4 illustrates an example hierarchical structure of a VFS instance (e.g., a file system) in a cluster (such as a virtualized file server) according to particular embodiments. A Cluster 402 contains two VFS instances, FS1 404 and FS2 406. For example, the 402 may be used to implement and/or may be implemented by a virtualized file server described herein, such as virtualized file server 202 (deleted) and/or virtualized file server 210 (deleted) of FIG. 2 (deleted). Each VFS instance as shown in FIG. 4 may be identified by a name such as “\\instance”, e.g., “\\FS1” for WINDOWS file systems, or a name such as “instance”, e.g., “FS1” for UNIX-type file systems. The VFS instance FS1 404 contains shares, including Share-1 408 and Share-2 410. Shares may have names such as “Users” for a share that stores user home directories, or the like. Each share may have a path name such as \\FS1\Share-1 or \\FS1\Users. As an example and not by way of limitation, a share may correspond to a disk partition or a pool of file system blocks on WINDOWS and UNIX-type file systems. As another example and not by way of limitation, a share may correspond to a folder or directory on a VFS instance. Shares may appear in the file system instance as folders or directories to users of user VMs. Share-1 408 includes two folders, Folder-1 416, and Folder-2 418, and may also include one or more files (e.g., files not in folders). Each folder 416, 418 may include one or more files 422, 424. Share-2 410 includes a folder Folder-3 412, which includes a file File-2 414. Each folder has a folder name such as “Folder-1”, “Users”, or “Sam” and a path name such as “\\FS1\Share-1 \Folder-1” (WINDOWS) or “share-1:/fs1/Users/Sam” (UNIX). Similarly, each file has a file name such as “File-1” or “Forecast.xls” and a path name such as “\\FS1\Share-1 \Folder-1 \File-1” or “share-1:/fs1/Users/Sam/Forecast.xls”.

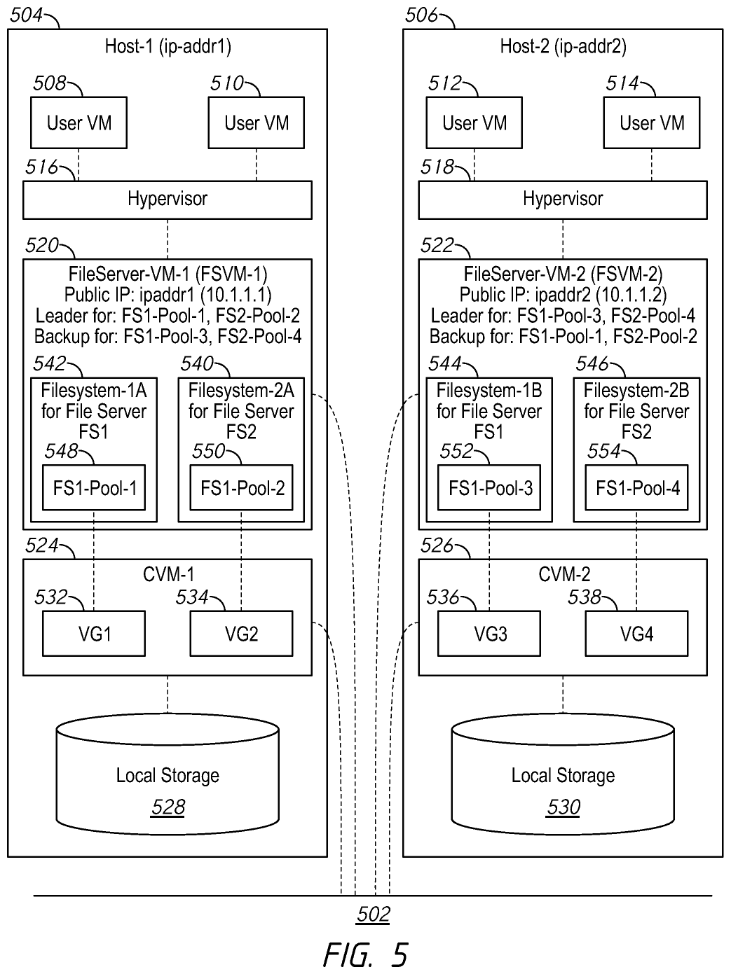

FIG. 5 illustrates two example host machines 504 and 506, each providing file storage services for portions of two VFS instances FS1 and FS2 according to particular embodiments. The first host machine, Host-1 202, includes two user VMs 508, 510, a Hypervisor 516, a FSVM named FileServer-VM-1 (abbreviated FSVM-1) 520, a Controller/Service VM named CVM-1 524, and local storage 528. Host-1's FileServer-VM-1 520 has an IP (Internet Protocol) network address of 10.1.1.1, which is an address of a network interface on Host-1 504. Host-1 has a hostname ip-addr1, which may correspond to Host-1's IP address 10.1.1.1. The second host machine, Host-2 506, includes two user VMs 512, 514, a Hypervisor 518, a File Server VM named FileServer-VM-2 (abbreviated FSVM-2) 522, a Controller/Service VM named CVM-2 526, and local storage 530. Host-2's FileServer-VM-2 522 has an IP network address of 10.1.1.2, which is an address of a network interface on Host-2 506.

In particular embodiments, file systems FileSystem-1A 542 and FileSystem-2A 540 implement the structure of files and folders for portions of the FS1 and FS2 file server instances, respectively, that are located on (e.g., served by) FileServer-VM-1 520 on Host-1 504. Other file systems on other host machines may implement other portions of the FS1 and FS2 file server instances. The file systems 542 and 540 may implement the structure of at least a portion of a file server instance by translating file system operations, such as opening a file, writing data to or reading data from the file, deleting a file, and so on, to disk I/O operations such as seeking to a portion of the disk, reading or writing an index of file information, writing data to or reading data from blocks of the disk, allocating or de-allocating the blocks, and so on. The file systems 542, 540 may thus store their file system data, including the structure of the folder and file hierarchy, the names of the storage items (e.g., folders and files), and the contents of the storage items on one or more storage devices, such as local storage 528. The particular storage device or devices on which the file system data for each file system are stored may be specified by an associated file system pool (e.g., 548 and 550). For example, the storage device(s) on which data for FileSystem-1A 542 and FileSystem-2A, 540 are stored may be specified by respective file system pools FS1-Pool-1 548 and FS2-Pool-2 550. The storage devices for the pool may be selected from volume groups provided by CVM-1 524, such as volume group VG1 532 and volume group VG2 534. Each volume group 532, 534 may include a group of one or more available storage devices that are present in local storage 528 associated with (e.g., by iSCSI communication) the CVM-1 524. The CVM-1 524 may be associated with a local storage 528 on the same host machine 202 as the CVM-1 524, or with a local storage 530 on a different host machine 506. The CVM-1 524 may also be associated with other types of storage, such as cloud storage, networked storage or the like. Although the examples described herein include particular host machines, virtual machines, file servers, file server instances, file server pools, CVMs, volume groups, and associations there between, any number of host machines, virtual machines, file servers, file server instances, file server pools, CVMs, volume groups, and any associations there between are possible and contemplated.

In particular embodiments, the file system pool 548 may associate any storage device in one of the volume groups 532, 534 of storage devices that are available in local storage 528 with the file system FileSystem-1A 542. For example, the file system pool FS1-Pool-1 548 may specify that a disk device named hd1 in the volume group VG1 532 of local storage 528 is a storage device for FileSystem-1A 542 for file server FS1 on FSVM-1 520. A file system pool FS2-Pool-2 550 may specify a storage device FileSystem-2A 550 for file server FS2 on FSVM-1 520. The storage device for FileSystem-2A 540 may be, e.g., the disk device hd1, or a different device in one of the volume groups 532, 534, such as a disk device named hd2 in volume group VG2 534. Each of the file systems FileSystem-1A 542, FileSystem-2A 540 may be, e.g., an instance of the NTFS file system used by the WINDOWS operating system, of the UFS Unix file system, or the like. The term “file system” may also be used herein to refer to an instance of a type of file system, e.g., a particular structure of folders and files with particular names and content.

In one example, referring to FIG. 4 and FIG. 5, an FS1 hierarchy rooted at File Server FS1 404 may be located on FileServer-VM-1 520 and stored in file system instance FileSystem-1A 542. That is, the file system instance FileSystem-1A 542 may store the names of the shares and storage items (such as folders and files), as well as the contents of the storage items, shown in the hierarchy at and below File Server FS1 404. A portion of the FS1 hierarchy shown in FIG. 4, such the portion rooted at Folder-2 418, may be located on FileServer-VM-2 522 on Host-2 506 instead of FileServer-VM-1 520, in which case the file system instance FileSystem-1B 544 may store the portion of the FS1 hierarchy rooted at Folder-2 418, including Folder-3 412, Folder-4 420 and File-3 424. Similarly, an FS2 hierarchy rooted at File Server FS2 406 in FIG. 4 may be located on FileServer-VM-1 520 and stored in file system instance FileSystem-2A 540. The FS2 hierarchy may be split into multiple portions (not shown), such that one portion is located on FileServer-VM-1 520 on Host-1 504, and another portion is located on FileServer-VM-2 522 on Host-2 506 and stored in file system instance FileSystem-2B 546.

In particular embodiments, FileServer-VM-1 (abbreviated FSVM-1) 520 on Host-1 504 is a leader for a portion of file server instance FS1 and a portion of FS2, and is a backup for another portion of FS1 and another portion of FS2. The portion of FS1 for which FileServer-VM-1 520 is a leader corresponds to a storage pool labeled FS1-Pool-1 548. FileServer-VM-1 is also a leader for FS2-Pool-2 550, and is a backup (e.g., is prepared to become a leader upon request, such as in response to a failure of another FSVM) for FS1-Pool-3 552 and FS2-Pool-4 554 on Host-2 506. In particular embodiments, FileServer-VM-2 (abbreviated FSVM-2) 522 is a leader for a portion of file server instance FS1 and a portion of FS2, and is a backup for another portion of FS1 and another portion of FS2. The portion of FS1 for which FSVM-2 522 is a leader corresponds to a storage pool labeled FS1-Pool-3 552. FSVM-2 522 is also a leader for FS2-Pool-4 554, and is a backup for FS1-Pool-1 548 and FS2-Pool-2 550 on Host-1 504.

In particular embodiments, the file server instances FS1, FS2 provided by the FSVMs 520 and 522 may be accessed by user VMs 508, 510, 512 and 514 via a network file system protocol such as SMB, CIFS, NFS, or the like. Each FSVM 520 and 522 may provide what appears to client applications on user VMs 508, 510, 512 and 514 to be a single file system instance, e.g., a single namespace of shares, files and folders, for each file server instance. However, the shares, files, and folders in a file server instance such as FS1 may actually be distributed across multiple FSVMs 520 and 522. For example, different folders in the same file server instance may be associated with different corresponding FSVMs 520 and 522 and CVMs 524 and 526 on different host machines 504 and 506.

The example file server instance FS1 404 shown in FIG. 4 has two shares, Share-1 408 and Share-2 410. Share-1 408 may be located on FSVM-1 520, CVM-1 524, and local storage 528. Network file system protocol requests from user VMs to read or write data on file server instance FS1 404 and any share, folder, or file in the instance may be sent to FSVM-1 520. FSVM-1 520 (or another component, such as a hypervisor in some examples) may determine whether the requested data, e.g., the share, folder, file, or a portion thereof, referenced in the request, is located on FSVM-1, and FSVM-1 is a leader for the requested data. If not, FSVM-1 may respond to the requesting User-VM with an indication that the requested data is not covered by (e.g., is not located on or served by) FSVM-1. Otherwise, the requested data is covered by (e.g., is located on or served by) FSVM-1, so FSVM-1 may send iSCSI protocol requests to a CVM that is associated with the requested data. Note that the CVM associated with the requested data may be the CVM-1 524 on the same host machine 202 as the FSVM-1, or a different CVM on a different host machine 506, depending on the configuration of the VFS. In this example, the requested Share-1 is located on FSVM-1, so FSVM-1 processes the request. To provide for path availability, multipath I/O (MPIO) may be used for communication with the FSVM, e.g., for communication between FSVM-1 and CVM-1. The active path may be set to the CVM that is local to the FSVM (e.g., on the same host machine) by default. The active path may be set to a remote CVM instead of the local CVM, e.g., when a failover occurs.

Continuing with the data request example, the associated CVM is CVM 524, which may in turn access the storage device associated with the requested data as specified in the request, e.g., to write specified data to the storage device or read requested data from a specified location on the storage device. In this example, the associated storage device is in local storage 528, and may be an HDD or SSD. CVM-1 524 may access the HDD or SSD via an appropriate protocol, e.g., iSCSI, SCSI, SATA, or the like. CVM 110a may send the results of accessing local storage 528, e.g., data that has been read, or the status of a data write operation, to CVM 524 via, e.g., SATA, which may in turn send the results to FSVM-1 520 via, e.g., iSCSI. FSVM-1 520 may then send the results to user VM via SMB through the Hypervisor 516.

Share-2 410 may be located on FSVM-2 522, on Host-2. Network file service protocol requests from user VMs to read or write data on Share-2 may be directed to FSVM-2 522 on Host-2 by other FSVMs. Alternatively, user VMs may send such requests directly to FSVM-2 522 on Host-2, which may process the requests using CVM-2 526 and local storage 530 on Host-2 as described above for FSVM-1 520 on Host-1.

A file server instance such as FS1 404 in FIG. 4 may appear as a single file system instance (e.g., a single namespace of folders and files that are accessible by their names or pathnames without regard for their physical locations), even though portions of the file system are stored on different host machines. Since each FSVM may provide a portion of a file server instance, each FSVM may have one or more “local” file systems that provide the portion of the file server instance (e.g., the portion of the namespace of files and folders) associated with the FSVM.

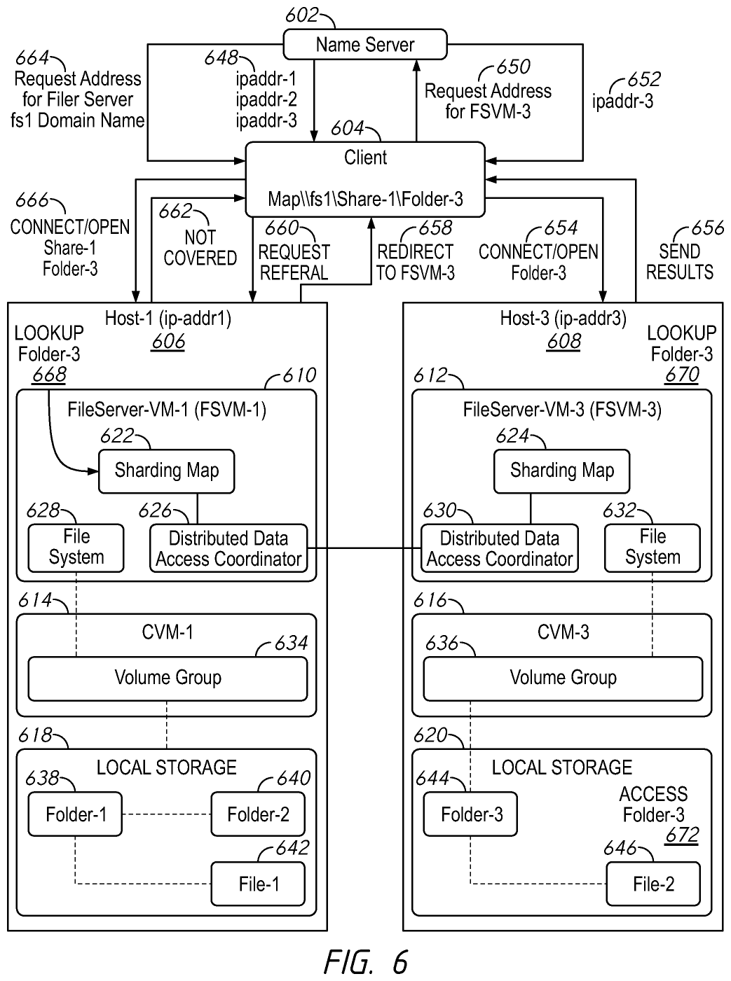

FIG. 6 illustrates example interactions between a client 604 and host machines 606 and 608 on which different portions of a VFS instance are stored according to particular embodiments. A client 604, e.g., an application program executing in one of the user VMs and on the host machines of a virtualized file server described herein requests access to a folder \\FS1.domain.name\Share-1\Folder-3. The request may be in response to an attempt to map \\FS1.domain.name\Share-1 to a network drive in the operating system executing in the user VM followed by an attempt to access the contents of Share-1 or to access the contents of Folder-3, such as listing the files in Folder-3.

FIG. 6 shows interactions that occur between the client 604, FSVMs 610 and 612 on host machines 606 and 608, and a name server 602 when a storage item is mapped or otherwise accessed. The name server 602 may be provided by a server computer system, such as one or more of the host machines 606, 608 or a server computer system separate from the host machines 606, 608. In one example, the name server 602 may be provided by an ACTIVE DIRECTORY service executing on one or more computer systems and accessible via the network. The interactions are shown as arrows that represent communications, e.g., messages sent via the network. Note that the client 604 may be executing in a user VM, which may be co-located with one of the FSVMs 610 and 612. In such a co-located case, the arrows between the client 604 and the host machine on which the FSVM is located may represent communication within the host machine, and such intra-host machine communication may be performed using a mechanism different from communication over the network, e.g., shared memory or inter process communication.

In particular embodiments, when the client 604 requests access to Folder-3, a VFS client component executing in the user VM may use a distributed file system protocol such as MICROSOFT DFS, or the like, to send the storage access request to one or more of the FSVMs of FIGS. 3-4. To access the requested file or folder, the client determines the location of the requested file or folder, e.g., the identity and/or network address of the FSVM on which the file or folder is located. The client may query a domain cache of FSVM network addresses that the client has previously identified (e.g., looked up). If the domain cache contains the network address of an FSVM associated with the requested folder name \\FS1.domain.name\Share-1 \Folder-3, then the client retrieves the associated network address from the domain cache and sends the access request to the network address, starting at step 664 as described below.

In particular embodiments, at step 664, the client may send a request for a list of addresses of FSVMs to a name server 602. The name server 602 may be, e.g., a DNS server or other type of server, such as a MICROSOFT domain controller (not shown), that has a database of FSVM addresses. At step 648, the name server 602 may send a reply that contains a list of FSVM network addresses, e.g., ip-addr1, ip-addr2, and ip-addr3, which correspond to the FSVMs in this example. At step 666, the client 604 may send an access request to one of the network addresses, e.g., the first network address in the list (ip-addr1 in this example), requesting the contents of Folder-3 of Share-1. By selecting the first network address in the list, the particular FSVM to which the access request is sent may be varied, e.g., in a round-robin manner by enabling round-robin DNS (or the like) on the name server 602. The access request may be, e.g., an SMB connect request, an NFS open request, and/or appropriate request(s) to traverse the hierarchy of Share-1 to reach the desired folder or file, e.g., Folder-3 in this example.

At step 668, FileServer-VM-1 610 may process the request received at step 666 by searching a mapping or lookup table, such as a sharding map 622, for the desired folder or file. The map 622 maps stored objects, such as shares, folders, or files, to their corresponding locations, e.g., the names or addresses of FSVMs. The map 622 may have the same contents on each host machine, with the contents on different host machines being synchronized using a distributed data store as described below. For example, the map 622 may contain entries that map Share-1 and Folder-1 to the File Server FSVM-1 610, and Folder-3 to the File Server FSVM-3 612. An example map is shown in Table 1 below. While the example of FIG. 6 is depicted and described with respect to the FSVM processing the request, in some examples, one or more other components of a virtualized system may additionally or instead process the request (e.g., a CVM and/or a hypervisor).

| Stored Object | Location |
|---|---|
| Folder-1 | FSVM-1 |
| Folder-2 | FSVM-1 |
| File-1 | FSVM-1 |
| Folder-3 | FSVM-3 |
| File-2 | FSVM-3 |

In particular embodiments, the map 622 or 624 may be accessible on each of the host machines. The maps may be copies of a distributed data structure that are maintained and accessed at each FSVM using a distributed data access coordinator 626 and 630. The distributed data access coordinator 626 and 630 may be implemented based on distributed locks or other storage item access operations. Alternatively, the distributed data access coordinator 626 and 630 may be implemented by maintaining a master copy of the maps 622 and 624 at a leader node such as the host machine 608, and using distributed locks to access the master copy from each FSVM 610 and 612. The distributed data access coordinator 626 and 630 may be implemented using distributed locking, leader election, or related features provided by a centralized coordination service for maintaining configuration information, naming, providing distributed synchronization, and/or providing group services (e.g., APACHE ZOOKEEPER or other distributed coordination software). Since the map 622 indicates that Folder-3 is located at FSVM-3 612 on Host-3 608, the lookup operation at step 668 determines that Folder-3 is not located at FSVM-1 on Host-1 606. Thus, at step 662 the FSVM-1 610 (or other component of the virtualized system) sends a response, e.g., a “Not Covered” DFS response, to the client 604 indicating that the requested folder is not located at FSVM-1. At step 660, the client 604 sends a request to FSVM-1 for a referral to the FSVM on which Folder-3 is located. FSVM-1 uses the map 622 to determine that Folder-3 is located at FSVM-3 on Host-3 608, and at step 658 returns a response, e.g., a “Redirect” DFS response, redirecting the client 604 to FSVM-3. The client 604 may then determine the network address for FSVM-3, which is ip-addr3 (e.g., a host name “ip-addr3.domain.name” or an IP address, 10.1.1.3). The client 604 may determine the network address for FSVM-3 by searching a cache stored in memory of the client 604, which may contain a mapping from FSVM-3 to ip-addr3 cached in a previous operation. If the cache does not contain a network address for FSVM-3, then at step 650 the client 604 may send a request to the name server 602 to resolve the name FSVM-3. The name server may respond with the resolved address, ip-addr3, at step 652. The client 604 may then store the association between FSVM-3 and ip-addr3 in the client's cache.

In particular embodiments, failure of FSVMs may be detected using the centralized coordination service. For example, using the centralized coordination service, each FSVM may create a lock on the host machine on which the FSVM is located using ephemeral nodes of the centralized coordination service (which are different from host machines but may correspond to host machines). Other FSVMs may volunteer for leadership of resources of remote FSVMs on other host machines, e.g., by requesting a lock on the other host machines. The locks requested by the other nodes are not granted unless communication to the leader host machine is lost, in which case the centralized coordination service deletes the ephemeral node and grants the lock to one of the volunteer host machines and, which becomes the new leader. For example, the volunteer host machines may be ordered by the time at which the centralized coordination service received their requests, and the lock may be granted to the first host machine on the ordered list. The first host machine on the list may thus be selected as the new leader. The FSVM on the new leader has ownership of the resources that were associated with the failed leader FSVM until the failed leader FSVM is restored, at which point the restored FSVM may reclaim the local resources of the host machine on which it is located.

At step 654, the client 604 may send an access request to FSVM-3 612 at ip-addr3 on Host-3 608 requesting the contents of Folder-3 of Share-1. At step 670, FSVM-3 612 queries FSVM-3's copy of the map 624 using FSVM-3's instance of the distributed data access coordinator 630. The map 624 indicates that Folder-3 is located on FSVM-3, so at step 672 FSVM-3 accesses the file system 632 to retrieve information about Folder-3 644 and its contents (e.g., a list of files in the folder, which includes File-2 646) that are stored on the local storage 620. FSVM-3 may access local storage 620 via CVM-3 616, which provides access to local storage 620 via a volume group 636 that contains one or more volumes stored on one or more storage devices in local storage 620. At step 656, FSVM-3 may then send the information about Folder-3 and its contents to the client 604. Optionally, FSVM-3 may retrieve the contents of File-2 and send them to the client 604, or the client 604 may send a subsequent request to retrieve File-2 as needed.

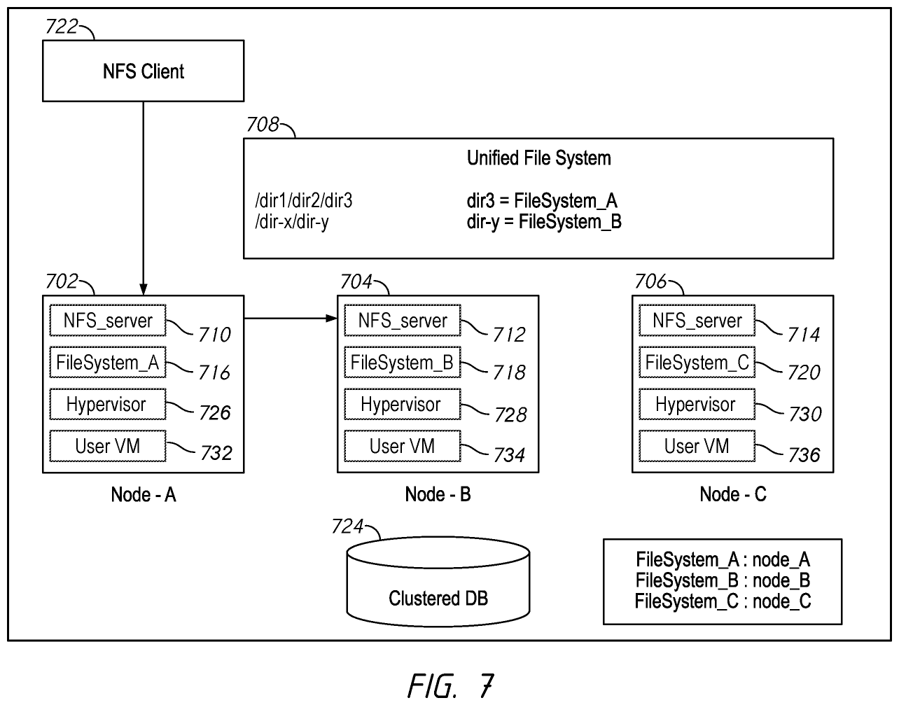

FIG. 7 is a schematic illustration of a system including linked or connected shares, arranged in accordance with examples described herein.

Recall that, in traditional clustered systems, when file shares are created on a file server, each file share may include its own control attributes (e.g., control polices, policies, etc.). As a result, in some examples, each share may have its own namespace, and may need to be accessed separately. In some examples, while creating multiple shares may allow setting different control attributes and/or policies, the creation of multiple namespaces may often result in a client needing to mount and access each share individually.

In some example embodiments descried herein shares (e.g., shares presenting one or more namespaces, etc.) are connected to create a unified namespace while simultaneously retaining each share's unique attributes (e.g., policies, control policies, etc.) determined during share creation (e.g., by an administrative system, etc.). In some examples, and as described herein, a clustered virtualized environment may include one or more host machines, such as host machines 202, 208, and 216 of FIG. 2. In some examples, each host machine may include one or more File Server Virtual Machines (FSVMs), such as FSVMs 204, 212, and 220 of FIG. 2. In some examples, each FSVM may be associated with (e.g., may receive and/or process I/O requests for) one or more file shares, such as share-1 408 of file server 1 404 and share-2 410 of file server 2 406, as illustrated in FIG. 4 and described herein. As should be appreciated, additional and/or alternative shares may be created on file servers 404 and 406 of FIG. 4. The shares may include storage items (e.g., data, files, folders) which may be distributed across storage devices in a storage pool of the virtualized file server. The storage pool may include local storage devices of the computing nodes used to host the virtualized file server (e.g., used to host one or more FSVMs). In some examples, when multiple shares are created on a file server, each share may be associated with and/or include its own control attributes (e.g., control policies, policies, and the like) and namespace. In some examples, the control attributes may be the same. In some examples, the control attributes may be different. In some examples, each share may share one or more control attribute in common. In some examples, control attributes may include but are not limited to snapshot schedule, read/write access, data distribution, replication attributes, data tiering attributes, quota attributes, and the like.

In the example of FIG. 7, three host machines (e.g., computing nodes) are shown—node 702, node 704, and node 706. The three nodes may form a virtualized file server as described herein and may be used to implement and/or may be implemented by any of the virtualized file servers described herein, including with reference to FIG. 1, FIG. 3, and/or FIG. 5. In the example of FIG. 7, each computing node may host a file server, e.g., a file server virtual machine (such as NFS_servers 710, 712, and/or 714, each also described herein as FSVMs 710, 712, and/or 714). In some examples, node 702 may host FSVM 710, node 704 may hose FSVM 712, and/or node 706 may hos FSVM 714. As should be appreciated, while a single FSVM is shown per node, it is to be understood that in other examples additional and/or alternative FSVMs may be hosted on each node. Each file server is illustrated as maintaining a particular file share (labeled in FIG. 7 as a file system). For example, FSVM 710 may maintain share 716 (e.g., FileSystem_A), FSVM 712 may maintain share 718 (e.g., FileSystem_B), and FSVM 714 may maintain share 720 (e.g., FileSystem_C). It is to be understood that additional and/or alternative configurations are possible—e.g., more than one share may be maintained by an FSVM in some examples, and in some examples a single share may be shared across multiple file servers (FSVMs).

In some examples, the nodes described herein may include one or more hypervisors, and/or one or more user virtual machines (VMs). For example and as illustrated, node 702 includes hypervisor 726 and user VM 732. Node 704 includes hypervisor 728 and user VM 734. Node 706 includes hypervisor 730 and user VM 736. As should be appreciated, while only one hypervisor and one user VM is shown per node of FIG. 7, additional and/or alternative hypervisors and/or user VMs may be included in each node, and is contemplated to be within the scope of this disclosure. Further, while not shown, additional and/or alternative components may be included in node 702, 704, and 706 that may assist in implementing the systems and methods described herein.

As described herein, in some examples, when creating one or more shares, that may also create multiple user-facing namespaces (e.g., namespaces from the client side), where each namespace may be associated with a created share. Accordingly, and in some examples, there may be a namespace for each of share 716, share 718, and share 720, as seen by a client, such as client 722. The client may be a process operating in a VM or container located one more nodes of a virtualized file server, such as on node 702, node 704, and/or node 706. In some examples, the client may be external to the virtualized file server. As shown in FIG. 7, the client may be a network file server (NFS) client, although other protocols may be used in other examples.

Operationally, and in some examples, to access each share a client may need to mount each created share individually. So, in some examples, the client 722 may need to mount share 716 separately from share 718. In some examples, client 722 may need to mount share 718 separately from share 720. In some examples, client 722 may need to mount share 716 separate from 720. A file server may be able to distribute data from one share to multiple cluster nodes at the top level of a directory. However, within one namespace or share, it may not be possible to have different snapshot schedules for different directories. Further, it is not possible to have different quota limits for different directories in a namespace. This is because, in part and in some examples, policies are stored at a file server level—e.g., policies for quotas, and replication, and data tiering, and snapshot schedules may be specified per share and may be stored in configuration information for the file server (e.g., configuration information for FSVM 710, FSVM 712, and/or FSVM 714).

Advantageously, embodiments described herein allow the connection of any share to another share, while maintaining each connected shares' individual attributes. In some examples, while each connected share maintains its per-share attributes, the namespace of the shares is connected. Advantageously, systems and methods described herein enable the creation of a big namespace by stitching (e.g., connecting) multiple shares together. Further, systems and methods described herein enable a specific directory to have a different snapshot schedule, as it could be a connected share at the place of the specific directory. Moreover, systems and methods described herein enable data distribution at multiple levels instead of data distribution happening only at the top directory level. Additionally, while it is possible to set a directory level quota, a directory that may need to, in some examples, have a different quota, may be set up using a different quota, and can be connected as a connected share.

In some examples, systems and methods described herein enable connecting shares to create a unified namespace while simultaneously retaining each share's unique attributes (e.g., policies) determined in some examples during share creation. Operationally, and in some examples, the connection may occur internally and at the protocol level. In some examples, this may mean that there may not need to be changes in the server-side file system or kernel, that the connected shares each retain their own attributes, and allows users (e.g., clients) access to distributed data at the directory level across shares. In this way, clients with access to multiple shares located in different namespaces, may access them using a single namespace due to the shares being connected (e.g. linked) in the backend and at the protocol layer.

As one non-limiting example, on creation of a share (e.g., share 716), an administrator may link the share to a particular directory location of another share. In some examples, share 716 may be linked to share 718. In some examples, share 718 may be linked to share 720. In some examples, share 716 may be linked to share 720. In some examples, the administrator may link the shares through an administrator system in communication with the virtualized file system and/or through a process running on node 702, node 704, and/or node 706. On creation of Share2 (e.g., share 718), the administrator may link Share2 (e.g., share 718) to Share1 (e.g., share 716) and/or a particular directory position of Share1 (e.g., Share1/user1).

In some examples, when a request for Share1/user1 is made to a file server that provides access to Share1 (e.g., to node 702 and/or FSVM 710), that file server may recognize the linked share, and forward the request to the linked Share2 (e.g., FSVM 712 and/or node 704). In some examples, and from the user's perspective, a single namespace is maintained on the front end. Recall that, in some examples, Share1 and Share2 may have different policies—e.g., different quotas or snapshot schedules, because those policies may be stored in configuration files for FSVM 710 and FSVM 712 separately, and may have been set, in some examples, during creation. In some examples, these types of policies, from the client perspective, can be different on a per-directory basis. For example, a particular directory may be associated with one share having one set of policies and another directory in the name space (e.g., a root directory or other directory) may be associated with another share having another set of policies.

In some examples, a mapping of the owner node(s) and/or owner FSVM(s) for each share may be maintained. As illustrated in FIG. 7, the clustered database 724 may maintain the mapping of the file system and the owner node(s). In some examples, the database 724 may be stored in a location accessible the virtualized file server, including node 702, node 704, and/or node 706. In some examples, the database 724 may be a distributed database. In some examples, the database 724 may be stored in a storage pool utilized by node 702, node 704, and/or node 706. In some examples, this may allow the NFS server (e.g., any of FSVM 710, FSVM 712, and/or FSVM 714, and/or other FSVMs not shown) to forward the client request to the correct owner node. In some examples, the NFS server has the configuration option and knows about the junctions and file system stitching locations. In some examples, the POSIX properties of these file systems are hidden and single inode space, and in some examples, the file system ID may be exposed to the client. In some examples, each of the file systems can have different properties (e.g., policies) exposed to the users like snapshot schedule, quota, data tiering destination.

As one non-limiting example, and as illustrated in FIG. 7, /dir1/dir2/dir3 may have an hourly snapshot schedule while /dir-x/dir-y may have a weekly snapshot schedule. In another non-limiting example, /dir1/dir2/dir3 may be tiering its cold data to S3:bucket-1 while/dir-x/dir-y can be tiering to S3:bucket-2. As should be appreciated, and as described herein, while policies such as replication, data tiering, quota, and snapshot scheduling are discussed, other policies not discussed herein are contemplated to be within the scope of this disclosure.

As one non-limiting example, there may exist a first share, Share A and a second share, Share B. The namespace for Share A may be, share-A namespace: /shareA_dir1/shareA_dir2. The namespace for Share B may be, share-B namespace: /shareB_dir1/shareB_dir2. Using systems and methods described herein, if share B is connected at shareA:/shareA_dir1/shareA_dir2, a client may see a single namespace as shareA:/shareA_dir1/shareA_dir2//shareB_dir1/shareB_dir2. Here, in some examples, both Share A and Share B will continue using their own attributes settings, such as, for examples, snapshot schedule, data distribution, etc. Additionally, Share B will distribute its top-level directories. As a result, in some examples, this allows users to distribute data at any (e.g., one or more, etc.) directory level.

In some examples, the share connection is completed at the protocol layer (e.g., level), and in some examples, is implemented by an administrator during share creation. In some examples, the protocol layer may include network attached storage (NAS) and/or server message block (SMB) file-based protocols. In some examples, there may be no changes in the sever-side file system or kernel to achieve the described connection. In some examples, the protocols may know which share to connect at what namespace form a configuration file (e.g., a config file). In some examples, for any (and/or one or more) client access, if the access is on the junction directory, the protocol layer may internally transfer the request to the connected child share. In some examples, this may allow for a seamless transfer to the client (and/or user, etc.).

In some examples, systems and methods described herein may allow the ability to construct a single unified namespace by stitching together multiple file systems.

In some examples, systems and methods described herein may allow multiple file systems to have their own properties like file system_id, inode space. In some examples, this is abstracted and unified namespace may show case its own set of properties.

In some examples, systems and methods described herein may allow users to choose certain points/junctions in the unified namespace where the properties of the stitched file system may be showcased instead of the unified namespace properties.

In some examples, systems and methods described herein may allow users to select different properties at certain namespace points which are typically provided only at the unified namespace level, e.g., snapshot schedule, quota, destination for tiering data.

In some examples, systems and methods described herein may assign each stitched files system a unique 16-bit identification (ID), which may, along with the inode number in each file system, make the client visible to inode. In some examples, this may enable a single inode space across the unified namespace.

In some examples, systems and methods described herein allow different file systems not needing to be on the same node. Instead, systems and methods described herein may maintain a clustered database, which tells the owner node for each file system. Using this information, in some examples, the nodes may forward the client request to the correct file system owner node.

In some examples, systems and methods described herein may enable snapshots at a per-file-system level, that have their own namespace. The different snapshot namespaces may also connected by the same way in some examples, to provide a single snapshot namespace.

In some examples, when a user needs separate properties at a certain namespace point, a new file system/share may be connected at the required junction. This file system may include the requested properties for snapshot schedule, quota, etc., and the like.

Operationally, and in one non-limiting example, client A may desire to access a particular location. In this example, client A may be a client associated with a first computing node have a first file server virtual machine (FSVM). For example, the client may be a user VM on that first computing node. In some examples, the FSVM may be configured to provide access to a first file share associated with a first namespace. In some examples, the first computing node may receive from client A a request to access a location. In some examples, the first computing node may determine that the requested location is at a second file share associated with a second namespace, and that the second file share is linked to the first file share. In some examples, information identifying the links between file shares, such as information that an administrator of an administrative system has linked two file shares (e.g., at file share creation) may be stored. In some examples, this information may comprise mapping or other information indicative of whether a file share has been linked with another (and/or one or more) file shares. In some examples, an analysis (e.g., a review, etc.) of this information may be used to determine whether a share (e.g., the second share, etc.) is linked to another share (e.g., the first share). In some examples, the first computing one may determine that the second file share may be hosted by a second computing node. In some examples, the first file share and the second file share may be linked during and/or at file share creation by an administrator system.

In some examples, the first computing node may provide access to the second file share to client A, given that the first file share and the second file share are linked, and in some examples, are linked at the directory level. In this way, the first computing node may present the second file share associated with the second namespace as a unified namespace to client A, such that the second file share associated with the second namespace is accessible to client A at the first namespace. For example, a request provided to the first computing node for a storage item at a share associated with the second computing node may nonetheless be serviced by the first computing node. In some examples, the first file share may include (e.g., have, comprise, etc.) a first policy and the second share may include a second policy. In some examples, a folder in the directory may be associated with the second policy, and a root of the directory may be associated with the first policy. In some examples, while client A may see the first file share and the second file share as a unified namespace upon being provided access to the second file share at the first computing node, each file share may maintain their unique policies.

In some examples, and as described herein although not shown explicitly in each node 702, 704, and/or 706 of FIG. 7, the first file share may include storage items distributed across one or more storage devices in a storage pool. In some examples, the one or more storage devices may include a local storage device of the first computing node and/or other computing nodes of the distributed file server.

In some examples, a client, such as client A of the above example, may include a user virtual machine on a first computing node, such as user VM 732 on node 702 of FIG. 7.

In some examples, while providing access to a second file share at a second location hosted on a second computing node associated with a second namespace is discussed herein, it should be appreciated that more than one other file share may be linked on the back end, presented as a united namespace, and/or provided access too at a first computing node. In some examples, upon receiving the request from client A for the location, a file server virtual machine of the first computing node may determine the location is at the second file share and/or may provide access to the second file share to the client. As should be appreciated, additional and/or alternative components of systems and methods described herein may also determine the location is at the second file share and/or may provide access to the second file share to the client.

In some examples, a user interface may be provided by an administrator system allowing an administrator (and/or user, client, and the like, etc.) to set policies for shares upon share creation (and/or after share creation), as well as link shares together at the back end. In some examples, the user interface may provide access to add or subtract linked shares. In some examples, linked shares may be unlinked and relinked. In some examples, the user interface may provide other functionality to implement and facilitate the systems and methods described herein.

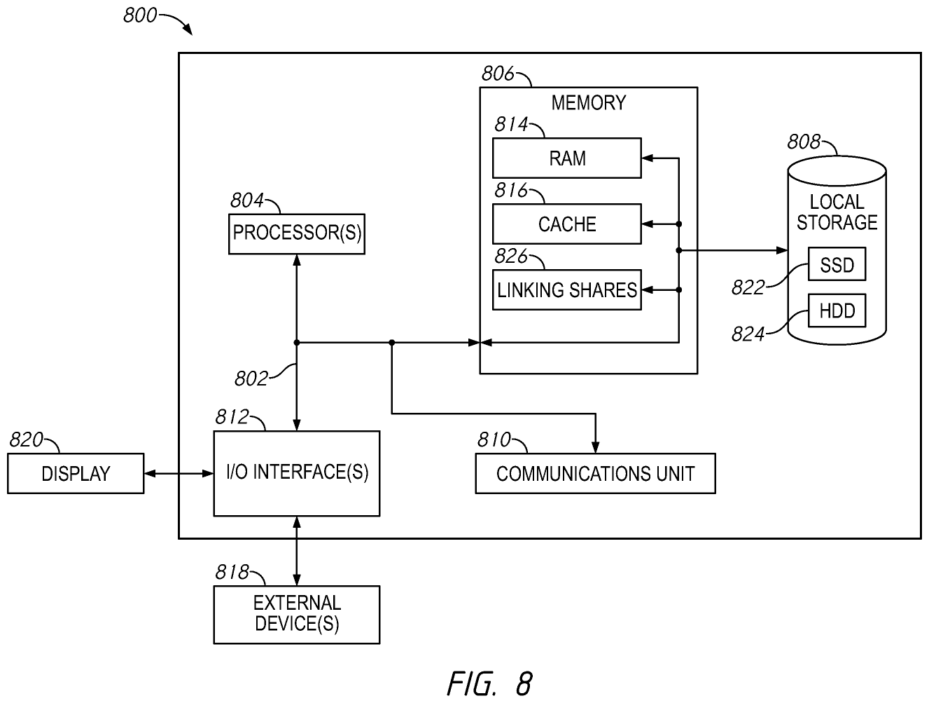

FIG. 8 depicts a block diagram of components of a computing system in accordance with examples described herein. It should be appreciated that FIG. 8 provides only an illustration of one implementation and does not imply any limitations with regard to the environments in which different embodiments may be implemented. Many modifications to the depicted environment may be made. The computing system may be used to implement and/or may be implemented by the file server manager 102 of FIG. 1, and/or any admin system as described herein, and/or any other system of FIG. 3, FIG. 5, and/or FIG. 7, for example. The components shown in FIG. 8 are exemplary only, and it is to be understood that additional, fewer, and/or different components may be used in other examples.

The computing node 800 includes one or more communications fabric(s) 802, which provide communications between one or more processor(s) 804, memory 806, local storage 808, communications unit 810, and/or I/O interface(s) 812. The communications fabric(s) 802 can be implemented with any architecture designed for passing data and/or control information between processors (such as microprocessors, communications and network processors, etc.), system memory, peripheral devices, and any other hardware components within a system. For example, the communications fabric(s) 802 can be implemented with one or more buses.

The memory 806 and the local storage 808 may be computer-readable storage media. In the example of FIG. 8, the memory 806 includes random access memory RAM 814 and cache 816. In general, the memory 806 can include any suitable volatile or non-volatile computer-readable storage media. In this embodiment, the local storage 808 includes an SSD 822 and an HDD 824. The memory 806 may include executable instructions for providing a file server manager, such as a file server manger as described herein. The instructions for providing a file server manager may be used to implement FSVM 710, FSVM 712, and/or FSVM 714, and/or be implemented by file server manager 102 of FIG. 1.

Various computer instructions, programs, files, images, etc. may be stored in local storage 808 and/or memory 806 for execution by one or more of the respective processor(s) 804 via one or more memories of memory 806. In some examples, local storage 808 includes a magnetic HDD 824. Alternatively, or in addition to a magnetic hard disk drive, local storage 808 can include the SSD 822, a semiconductor storage device, a read-only memory (ROM), an erasable programmable read-only memory (EPROM), a flash memory, or any other computer-readable storage media that is capable of storing program instructions or digital information.

The media used by local storage 808 may also be removable. For example, a removable hard drive may be used for local storage 808. Other examples include optical and magnetic disks, thumb drives, and smart cards that are inserted into a drive for transfer onto another computer-readable storage medium that is also part of local storage 808.

Communications unit 810, in some examples, provides for communications with other data processing systems or devices. For example, communications unit 810 may include one or more network interface cards. Communications unit 810 may provide communications through the use of either or both physical and wireless communications links.

I/O interface(s) 812 may allow for input and output of data with other devices that may be connected to computing node 800. For example, I/O interface(s) 812 may provide a connection to external device(s) 818 such as a keyboard, a keypad, a touch screen, and/or some other suitable input device. External device(s) 818 can also include portable computer-readable storage media such as, for example, thumb drives, portable optical or magnetic disks, and memory cards. Software and data used to practice embodiments of the present invention can be stored on such portable computer-readable storage media and can be loaded onto and/or encoded in memory 806 and/or local storage 808 via I/O interface(s) 812 in some examples. I/O interface(s) 812 may connect to a display 820. Display 820 may provide a mechanism to display data to a user and may be, for example, a computer monitor.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. At least one non-transitory computer readable medium encoded with instructions which, when executed, cause a computing node to perform operations, the operations comprising:
receiving, at a first computing node having a file server virtual machine (FSVM) configured to provide access to a first file share associated with a first namespace, a request by a client to access a location in a second namespace;
determining, at the first computing node, the location is at a second file share, linked to the first file share, the second file share hosted by a second computing node; and
providing, from the first computing node, access to the second file share to the client.

2. The non-transitory computer readable medium of claim 1, wherein the first namespace associated with the first file share and the second namespace associated with the second file share are linked at a directory level.

3. The non-transitory computer readable medium of claim 2, wherein the first file share has a first policy and the second file share has a second policy, and wherein a folder in the directory is associated with the second policy and a root of the directory is associated with the first policy.

4. The non-transitory computer readable medium of claim 3, wherein the first policy, the second policy, or a combination thereof, are replication policies.

5. The non-transitory computer readable medium of claim 3, wherein the first policy, the second policy, or a combination thereof, are scheduling policies.

6. The non-transitory computer readable medium of claim 3, wherein the first policy, the second policy, or a combination thereof, are data tiering policies.

7. The non-transitory computer readable medium of claim 3, wherein the first policy, the second policy, or a combination thereof, are quota policies.

8. The non-transitory computer readable medium of claim 1, wherein the first file share associated with the first namespace and the second file share associated with the second namespace, are linked at a directory level and present as a unified namespace to the client such that the second file share associated with the second namespace is accessible to the client at the first namespace.

9. The non-transitory computer readable medium of claim 1, wherein the client is a network file system (NFS) client.

10. The non-transitory computer readable medium of claim 1, wherein the first file share includes storage items distributed across one or more storage devices in a storage pool, the one or more storage devices including a local storage device of the first computing node.

11. The non-transitory computer readable medium of claim 10, wherein the client comprises a user virtual machine on the first computing node.

12. The non-transitory computer readable medium of claim 1, the operations further comprising:
receiving, at the first computing node, a request by the client to access another location in a third namespace;
determining, at the first computing node, the another location is at a third file share, linked to the first file share, the third file share hosted by a third computing node; and
providing, from the first computing node, access to the third file share to the client.

13. The non-transitory computer readable medium of claim 1, wherein the first computing node comprises the FSVM, and wherein the FSVM determines the location is at the second file share, provides access to the second file share to the client, or a combination thereof.

14. A method comprising:
transmitting, by a client of a first computing node having a file server virtual machine (FSVM) configured to provide access to a first file share associated with a first namespace, a request to access a location in a second namespace;
determining, at the computing node, the location is at a second file share hosted by a second computing node, wherein the second file share and the first file share are linked; and
receiving, from the first computing node, access to the second file share.

15. The method of claim 14, wherein the first namespace associated with the first file share and the second namespace associated with the second file share are linked at a directory level.

16. The method of claim 15, wherein the first file share has a first policy and the second file share has a second policy, and wherein a folder in the directory is associated with the second policy and a root of the directory is associated with the first policy.

17. The method of claim 16, wherein the first policy, the second policy, or a combination thereof, are replication policies.

18. The method of claim 16, wherein the first policy, the second policy, or a combination thereof, are scheduling policies.

19. The method of claim 16, wherein the first policy, the second policy, or a combination thereof, are data tiering policies.

20. The method of claim 16, wherein the first policy, the second policy, or a combination thereof, are quota policies.

21. The method of claim 14, wherein the first file share associated with the first namespace and the second file share associated with the second namespace, are linked at a directory level and present as a unified namespace to the client such that the second file share associated with the second namespace is accessible to the client at the first namespace.

22. The method of claim 14, wherein the client is a network file system (NFS) client.

23. The method of claim 14, wherein the first file share includes storage items distributed across one or more storage devices in a storage pool, the one or more storage devices including a local storage device of the first computing node.

24. The method of claim 23, wherein the client comprises a user virtual machine on the first computing node.

25. The method of claim 14, further comprising:
transmitting, by the client of the first computing node, a request to access another location in a third namespace;
determining, at the first computing node, the another location is a third file share hosted by a third computing node, wherein the third file share and the first file share are linked; and
receiving, from the first computing node, access to the third file share.

26. The method of claim 14, wherein the first computing node comprises the FSVM, and wherein the FSVM determines the location is at the second file share, provides access to the second file share to the client, or a combination thereof.

27. A system comprising:
a first computing node having a first file server virtual machine (FSVM) configured to provide access to a first file share associated with a first namespace;
a second computing node having a FSVM configured to provide access to a second file share associated with a second namespace;
an administrative system, communicatively coupled to the first computing node and the second computing node, and configured to link the first file share associated with the first namespace and the second file share associated with the second namespace, such that the first file share and the second file share present as a unified namespace; and
the first computing node further configured to:
receive, from a client and at the first computing node, a request to access a location;
determine, at the first computing node, the location is at the second namespace linked to the first namespace; and
provide, from the first computing node to the client, access to the second file share.

28. The system of claim 27, wherein the first namespace associated with the first file share and the second namespace associated with the second file share are linked at a directory level.

29. The system of claim 28, wherein the first file share has a first policy and the second file share has a second policy, and wherein a folder in the directory is associated with the second policy and a root of the directory is associated with the first policy.

30. The system of claim 29, wherein the first policy, the second policy, or a combination thereof, are replication policies.

31. The system of claim 29, wherein the first policy, the second policy, or a combination thereof, are scheduling policies.

32. The system of claim 29, wherein the first policy, the second policy, or a combination thereof, are data tiering policies.

33. The system of claim 29, wherein the first policy, the second policy, or a combination thereof, are quota policies.

34. The system of claim 27, wherein the first computing node is further configured to present the first file share associated with the first namespace and the second file share associated with the second namespace as the unified namespace to the client, such that the second file share associated with the second namespace is accessible to the client at the first namespace.

35. The system of claim 27, wherein the client is a network file system (NFS) client.

36. The system of claim 27, wherein the first file share includes storage items distributed across one or more storage devices in a storage pool, the one or more storage devices including a local storage device of the first computing node.

37. The system of claim 36, wherein the client comprises a user virtual machine on the first computing node.

38. The system of claim 27, wherein the first computing node further configured to:
receive, from the client at the first computing node, a request to access another location in a third namespace;
determine, at the first computing node, the another location is at a third file share, linked to the first file share, the third file share hosted by a third computing node; and
provide, from the first computing node, access to the third file share to the client.

39. The system of claim 27, wherein the first computing node comprises the FSVM, and wherein the FSVM determines the location is at the second file share, provides access to the second file share to the client, or a combination thereof.
